(19) United States
(12) Patent Application Publication
(10) Pub. No.: US 2022/0093935 A1
(43) Pub. Date: Mar. 24, 2022

(54) STABLE CERAMIC ANODES AND METHODS FOR PRODUCING AND USING THE SAME

(71) Applicant: University of Maryland, College Park, College Park, MD (US)

(72) Inventors: Mohammed Hussain ABDUL JABBAR, Farmington Hills, MI (US); Eric D. WACHSMAN, Fulton, MD (US)

(73) Assignee: University of Maryland, College Park, College Park, MD (US)

(21) Appl. No.: 17/479,654

(22) Filed: Sep. 20, 2021

Related U.S. Application Data
(60) Provisional application No. 63/080,452, filed on Sep. 18, 2020.

(51) Int. Cl. H01M 4/86; H01M 4/90; H01M 8/12

(52) U.S. Cl. CPC H01M 4/8621; H01M 4/9033; H01M 2008/1293; H01M 2004/8684; H01M 8/12

(57) ABSTRACT

The present disclosure provides a stable ceramic anode for a solid oxide fuel cell (SOFC) and a method for producing and using the same. In particular, anodes for solid oxide fuel cells disclosed herein can be operated at a significantly lower temperature than conventional SOFCs, and allow thermal and anode gas cycling under transient conditions. More significantly, anodes described in the present disclosure have a significantly higher long-term operability compared to a similar anode having a higher amount of electrocatalyst. In one particular embodiment, the stable ceramic anodes comprise (i) strontium-iron-cobalt-molybdenum oxide (SFCM) material; (ii) a first ion-conductor composition comprising an oxide of cerium or cerium that is doped with a rare-earth metal; and (iii) nanoparticles of an electrocatalyst comprising (a) a second ion-conductor and (b) nickel, a nickel alloy, or a combination thereof. The amount of electrocatalyst in said stable ceramic anode is less than 10 wt %.

### CROSS-REFERENCE TO RELATED APPLICATIONS

This application claims the priority to U.S. Provisional Application No. 63/080,452, filed Sep. 18, 2020, which is hereby incorporated by reference in its entirety.

### STATEMENT REGARDING FEDERALLY FUNDED RESEARCH

This invention was made with government support under ARPA-E DE-AR0000494 and NETL DE-FE0027897 awarded by the Department of Energy. The government has certain rights in the invention.

### FIELD OF THE INVENTION

The present disclosure relates to long-term stable ceramic anodes for solid oxide fuel cells (SOFCs) and methods for producing and using the same. In particular, the anodes for solid oxide fuel cells disclosed herein are capable of both operating at significantly lower temperatures than conventional SOFCs and enabling thermal and anode gas cycling under transient conditions, such as start-up and shut-down. More significantly, such anodes are stable over a long period of operation.

### BACKGROUND OF THE INVENTION

Solid oxide fuel cells (SOFCs) are efficient electrochemical energy conversion device that can convert chemical energy stored in a variety of fuels into electrical energy. Conventional SOFCs operate at high temperatures (e.g., ≥800° C.), leading to degradation and other issues that increase cost. Efforts are underway to lower the operating temperature of SOFCs to demonstrate reliable SOFCs at a lower cost.

One of the critical factors that hampers the deployment of low temperature solid oxide fuel cells (LT-SOFC) is anode instability. In particular, reduction/oxidation (redox) cycles during fuel-rich and fuel-starved conditions induce anodes of SOFC to fail. To overcome such limitations various ceramic anodes have been proposed for SOFC, including titanates (e.g., Sr_{0.99}Ti_{0.9}Nb_{0.1}O_{3-δ}), molybdates (e.g., Sr₂MgMoO_{6-δ}), chromates (e.g., La_{0.2}Sr_{0.7}Cr_{0.5}Mn_{0.5}O_{3-δ}), ferrites (e.g., La_{0.6}Sr_{0.4}Fe_{0.9}Mn_{0.1}O_{3-δ}) and vanadates (La_{0.8}Sr_{0.2}VO_{3-δ}). Of which, Sr₂MgMoO_{6-δ} (SMMO) based ceramic anodes, Sr₂FeNb_{0.2}Mo_{0.8}O_{6-δ}, Sr₂Fe_{1.5-x}CoₓMo_{0.5}O_{6-δ} (X=0, 0.5, 0.75, and 1) have shown to have excellent redox stability, and operate steadily even in H₂S-containing fuels at 800° C. Also, variants of SMMO such as Sr₂CoMoO₆ and Sr₂NiMoO₆ operate in hydrocarbon fuels (utilizing Co³⁺/Co²⁺ and Mo⁶⁺/Mo⁵⁺ as redox couples) at high temperatures (e.g., >800° C.). However, the insufficient catalytic activity of these ceramic anodes for fuel oxidation at low temperatures (e.g., ≤600° C.) greatly limits their application in a low-temperature solid oxide fuel cell (LT-SOFC).

Therefore, there is a need for SOFC anodes that can operate efficiently at a low-temperature. In addition, there is a continuing need for SOFC anodes that can withstand or undergo a large number of reduction/oxidation cycles and/or anodes that have a long-term stability during operation.

### BRIEF SUMMARY

Some aspects of the present disclosure are based on the discovery by the present inventors that ceramic anodes, such as strontium-iron-cobalt-molybdenum (SFCM), can withstand a large number of redox cycles without cracking that is observed in conventional SOFC anodes. More significantly, the present inventors have discovered that limiting the amount of electrocatalyst present in the ceramic anode increases the long-term stability of ceramic anodes. For example, when the electrocatalyst comprises nickel and gadolinium-cerium oxide, by limiting the total amount of electrocatalyst in the ceramic anode to less than 10 wt %, typically less than 8 wt %, often less than 5 wt % or less, combined with reducing the ratio of Ni to GDC in the electrocatalyst, one can increase the operability of the anode by at least 10%, typically by at least 25%, and often by at least 50% compared to a similar anode having the total amount of electrocatalyst of about 10 wt % with a 1:1 atomic/molecular ratio of Ni to GDC. Unless context requires otherwise, the weight % of the electrocatalyst refers to its weight relative to the total weight of the ceramic anode and the amount of nickel discussed herein refers to the amount of nickel in the electrocatalyst relative to the amount of ion conducting oxide in the electrocatalyst, e.g., Ni50-GDC corresponds to 50% Ni and 50% GDC on an atom basis (i.e., 50% Ni atom and 50% GDC compound) within the infiltrated electrocatalyst.

Other aspects of the disclosure are based on the discovery by the present inventors that addition of ion-conductor composition to SFCM-based anodes allow SOFCs to operate at a significantly lower temperature (e.g., less than about 800° C., typically less than about 750° C., often less than about 700° C., more often less than about 650° C., and most often about 600° C. or less) compared to conventional SOFCs.

Still other aspects of the disclosure provide a solid oxide fuel cell comprising: a cathode layer, an anode layer, and an electrolyte layer located between the cathode layer and the anode layer. Typically, the anode layer is any anode layer disclosed herein.

One particular aspect of the disclosure provides a stable ceramic anode composition for a solid oxide fuel cell (SOFC) having a porous surface. The stable ceramic anode composition comprises:
strontium-iron-cobalt-molybdenum oxide material (SFCM);
a first ion-conductor composition comprising an oxide of cerium or cerium that is doped with a rare-earth metal; and
nanoparticles of an electrocatalyst comprising (a) a second ion-conductor and (b) nickel, a nickel alloy, or a combination thereof, wherein said nanoparticles are infiltrated within said porous surface of said stable ceramic anode,
   wherein a total amount of the electrocatalyst in said stable ceramic anode of said infiltration is less than about 10% by weight. In some embodiments, the amount of electrocatalyst in the stable ceramic anode of the infiltration is about 5 wt % or less, typically less than about 5 wt % or less, and often about 3 wt % or less.

Yet in other embodiments, a ratio of SFCM to said ion-conductor composition is from about 5:1 to about 1:1 by weight. Still in other embodiments, said rare-earth metal is a lanthanide metal. Yet in other embodiments, said lanthanide metal comprises Gd, Pr, Nd, Sm, Y, La, Eu, Tb, Dy, Ho, Er, Tm, Yb, or a combination thereof. In one particular embodiment, said lanthanide metal comprises Gd, Pr, Nd, Sm, or a combination thereof.

In another embodiment, the total amount of said electrocatalyst composition is less than about 10 wt % relative to a total amount of said ceramic anode composition, typically about 8 wt % or less, often about 5 wt % or less, and most often less than about 5 wt %. In one particular embodiment, said electrocatalyst composition comprises nickel or an alloy of nickel in combination with a second ion-conductor comprising an oxide of cerium or cerium that is doped with a rare-earth metal. Still in other embodiments, said nickel alloy comprises cobalt, iron, tin, other transition metals, or a combination thereof. In one particular embodiment, said nickel alloy comprises cobalt, iron, tin, or a combination thereof.

In one specific embodiment, said electrocatalyst comprises nickel-gadolinium cerium oxide (Ni-GDC). In some instances, nickel in the electrocatalyst has a particle size of about 200 nm or less, typically 100 nm or less, often 75 nm or less, and most often 50 nm or less.

Still in other embodiments, said ion-conductor composition comprises gadolinium-doped cerium oxide (GDC). In some instances, said GDC is doped with cobalt. While the amount of cobalt can vary, in one particular embodiment, the amount of cobalt in said GDC is about 10 wt % or less, typically about 5 wt % or less, and often about 2 wt % or less.

Other aspects of the disclosure provide a solid oxide fuel cell (SOFC) comprising:
(a) a cathode layer;
(b) a stable ceramic anode layer having a less than 15% cell voltage reduction in galvanostatic mode over a period of 200 h; and
(c) an electrolyte layer located between said cathode layer and said ceramic anode layer.
   Generally, any stable ceramic anode disclosed herein can be used in SOFC.

In some embodiments, the solid oxide fuel cell further comprises a cathode functional layer (CFL) located between said cathode layer and said electrolyte layer. In some instances, said CFL comprises cobalt-doped GDC (Co-GDC). Still, in other embodiments, the CFL comprises (a) Fe, Cu, Bi, or a combination thereof and (b) GDC. Yet in another embodiment, the CFL comprises CeO₂.

Still in other embodiments, said stable ceramic anode layer known to one skilled in the art including SFCM anodes disclosed in a commonly assigned U.S. Pat. No. 10,938,052, which is incorporated herein by reference in its entirety, in combination with nanoparticles of electrocatalyst comprising (a) a second ion-conductor and (b) nickel, an alloy of nickel, or a combination thereof. In one particular embodiment, the stable ceramic anode layer comprises:
strontium-iron-cobalt-molybdenum oxide material (SFCM) of the formula: SrFeₓCo_{((1-x)/2)}Mo_{((1-x)/2)}O_{3±δ}, wherein x is 0.1-0.5 and δ is 0-1.5;
a first ion-conductor composition comprising an oxide of cerium or cerium that is doped with a rare-earth metal; and
nanoparticles of an electrocatalyst comprising (a) a second ion-conductor and (b) nickel, a nickel alloy, or a combination thereof,
   wherein said nanoparticles are infiltrated within said porous surface of ceramic anode. In one particular embodiment, said second ion-conductor comprises an oxide of cerium or cerium that is doped with a rare-earth metal,

Yet in other embodiments, the total amount of said electrocatalyst in said stable ceramic anode of said infiltrate is about 5% by weight or less. In one specific embodiment, said electrocatalyst comprises nickel and gadolinium cerium oxide (Ni-GDC). In some instances, the amount of nickel in the Ni-GDC electrocatalyst is about 25% or less on an atom basis.

### BRIEF DESCRIPTION OF THE DRAWINGS

FIG. 1A is an SEM image of an SFCM-based cell configuration.

FIG. 1B is a graph showing I-V characteristics at 550° C., 600° C., and 650° C. of SFCM-GDC anode based cells.

FIG. 1C is a graph showing open circuit voltage (OCV) at 600° C. as function of a number of fuel composition redox cycles configured for SFCM-GDC anode based cells as compared to Ni-GDC anode based cells.

FIG. 1D is a graph showing a peak power density (PDD) of SFCM-GDC anode based cells as compared to Ni-GDC anode based cells.

FIG. 1E shows Nyquist plots of cycling results of SFCM-GDC anode based cells as compared to Ni-GDC anode based cells.

FIG. 1F is a graph showing the deconvoluted ohmic and non-ohmic ASR of SFCM-GDC anode based cells as compared to Ni-GDC anode based cells.

FIG. 2A is a graph showing the SFCM-GDC cell voltage as a function of time under multiple redox cycles under a constant current load of 0.2 A/cm².

FIG. 2B is an enlarged view of the 11th and 29th redox cycle in FIG. 2A.

FIG. 2C is a graph showing I-V characteristics of the SFCM-GDC anode based cells for every five redox cycles under condition 2.

FIG. 3A is SEM micrographs of a fresh Ni-GDC anode based cell before any testing.

FIG. 3B is SEM micrographs of an Ni-GDC anode based cell after 8 redox cycles showing large dimensional change, including cracks along the Ni particles and appearance of honeycomb-shaped pores in the Ni particles.

FIG. 3C is SEM micrographs of an SFCM-GDC anode based cell before any testing.

FIG. 3D is SEM micrographs of an SFCM-GDC anode based cell after 30 cycles showing no significant changes to the microstructure.

FIG. 4A shows XRD of a fresh SFCM sample.

FIG. 4B shows XRD of the SFCM sample of FIG. 4A after 10 redox cycles showing that SFCM has the same crystal structure as the pristine SFCM as there are no detectable secondary phases.

FIG. 4C is a plot of oxidation relaxation curves using dilatometer showing negligible dimensional changes of SFCM after each of the five redox-cycling between air and 5% H₂.

FIG. 4D is a plot of reduction relaxation curves using dilatometer showing negligible dimensional changes of SFCM after each of the five redox-cycling between air and 5% H₂.

FIG. 4E is TGA and DSC curves of SFCM in air showing weight changes as a function of temperature and pO₂.

FIG. 4F is a TGA and DSC curves of SFCM in 5% H₂ showing weight changes as a function of temperature and pO₂.

FIG. 5 is a schematic illustration of a different possible redox reaction mechanisms for Ni-GDC and SFCM-GDC.

FIG. 6 is a schematic illustration of one example embodiment of SFCM-GDC anode showing a representative GDC coating thickness in the anode and distance between Ni—Ni particles.

FIG. 7 is a graph showing DC electrical conductivity of various ceramic anode materials including SFCM.

FIG. 8A is a schematic illustration of SFCM-based anode supported SOFC used in Example 2.

FIG. 8B is an SEM cross-sectional micrograph of the SOFC used in Example 2 where the labels 1, 2, 3, and 4 corresponds to the SOFC components mentioned in FIG. 8A.

FIG. 8C is a graph showing I-V characteristics of SFCM anode infiltrated with Ni10-GDC in humidified H₂.

FIG. 8D is a graph showing I-V characteristics of SFCM anode infiltrated with Ni10-GDC in humidified CH₄/H₂ gas mixture.

FIG. 8E is an impedance spectra under OCV of SFCM anode infiltrated with Ni10-GDC measured in CH₄/H₂ gas atmosphere at different temperatures showing overlapped contribution from electrolyte, cathode, and anode.

FIG. 9A is a graph showing differences in I-V characteristics of SFCM anode infiltrated with GDC, Ni10-GDC, Ni50-GDC, Ni75-GDC and Ni in humidified CH₄/H₂ gas mixture at 600° C.

FIG. 9B is a graph showing OCV and peak power density of SFCM based SOFCs infiltrated with varying Ni-to-GDC ratios (GDC, Ni10-GDC, Ni50-GDC, Ni75-GDC and Ni) in humidified CH₄/H₂ gas mixture at 600° C.

FIG. 9C is a graph of non-ohmic ASR of SFCM based SOFCs infiltrated with varying Ni-to-GDC ratios (GDC, Ni10-GDC, Ni50-GDC, Ni75-GDC and Ni) in humidified CH₄/H₂ gas mixture at 600° C.

FIG. 9D is a graph of ohmic ASR of SFCM based SOFCs infiltrated with varying Ni-to-GDC ratios (GDC, Ni10-GDC, Ni50-GDC, Ni75-GDC and Ni) in humidified CH₄/H₂ gas mixture at 600° C.

FIG. 10A is a graph showing I-V characteristics for Ni10-GDC infiltrated SFCM cell at initial (i.e., 0 h), 100 h, and 200 h.

FIG. 10B is an impedance spectra of Ni10-GDC infiltrated SFCM at initial, 100 h, and 200 h.

FIG. 10C is a graph showing I-V characteristics for Ni50-GDC infiltrated SFCM cell at initial (i.e., 0 h), 100 h, and 200 h.

FIG. 10D is an impedance spectra of Ni50-GDC infiltrated SFCM at initial, 100 h, and 200 h.

FIG. 10E is a graph showing I-V characteristics for Ni infiltrated SFCM cell at initial (i.e., 0 h), 100 h, and 200 h.

FIG. 10F is an impedance spectra of Ni infiltrated SFCM at initial, 100 h, and 200 h.

FIG. 10G is a graph showing differences in long-term cell voltage at a constant current of 0.2 A cm⁻² on SFCM anode infiltrated with Ni10-GDC, Ni50-GDC, and Ni only electrocatalyst.

FIG. 11A shows comparative SEM images of Ni10-GDC infiltrated SFCM surface at initial and after 200 h of operation in CH₄/H₂ gas mixture at 600° C.

FIG. 11B shows comparative SEM images of Ni50-GDC infiltrated SFCM surface at initial and after 200 h of operation in CH₄/H₂ gas mixture at 600° C.

FIG. 11C shows comparative SEM images of Ni infiltrated SFCM surface at initial and after 200 h of operation in CH₄/H₂ gas mixture at 600° C.

FIG. 11D is a schematic illustration of nickel particle formation on Ni10-GDC infiltrated SFCM surface initial and after 200 h of operation in CH₄/H₂ gas mixture at 600° C.

FIG. 11E is a schematic illustration of nickel particle formation on Ni50-GDC infiltrated SFCM surface initial and after 200 h of operation in CH₄/H₂ gas mixture at 600° C.

FIG. 11F is a schematic illustration of nickel particle formation on Ni on an SFCM infiltrated surface initially and after 200 h of operation in CH₄/H₂ gas mixture at 600° C.

FIG. 12A is a bar graph showing particle size distributions of Ni, Ni50-GDC and Ni10-GDC at initial and after 200 h of operation in CH₄/H₂ gas mixture at 600° C.

FIG. 12B is a graph showing average Ni particle sizes at the initial (darker data points) and after 200 h of operation (lighter data points) for SFCM with various amounts of Ni-to-GDC ratio infiltrants.

### DETAILED DESCRIPTION

Some aspects of the disclosure are based on the discovery by the present inventors of new ceramic anode compositions that were found to provide a significantly higher operational stability by limiting the amount of electrocatalyst infiltration. In some embodiments, the term “stable” refers to a ceramic anode that does not lead to SOFC failure after 20 or more, typically after 30 or more, often after 40 or more, still more often after 50 or more, and most often after 100 or more operational cycles or redox-cycles as determined by any of the methods disclosed herein. Alternatively, the term “stable” refers to a ceramic anode having a less than about 15%, typically about 10% or less, and often about 5% or less reduction of cell voltage in galvanostatic mode testing over a period of 200 h. Moreover, the term “stable” is used to denote increased time of anode operability, e.g., ceramic anode that can operate at least 95% of the initial cell voltage capacity (in galvanostatic mode testing) of at least about 10% or more, typically by at least about 25% or more, and often by at least about 50% or more operation time compared to a similar ceramic anode having the total amount of electrocatalyst of about 5 wt % or more. When referring to a numerical value, the terms “about” and “approximately” are used interchangeably herein and refer to being within an acceptable error range for the particular value as determined by one skilled in the art. Such a value determination depends at least in part on how the value is measured or determined, e.g., the limitations of the measurement system, i.e., the degree of precision required for a particular purpose. For example, the term “about” can mean within 1 or more than 1 standard deviation, per the practice in the art. Alternatively, the term “about” when referring to a numerical value can mean±20%, typically ±10%, often ±5% and more often ±1% of the numerical value. In general, however, where particular values are described in the application and claims, unless otherwise stated, the term “about” means within an acceptable error range for the particular value, typically within one standard deviation.

In one aspect of the disclosure, a stable ceramic anode composition for a solid oxide fuel cell (SOFC) is provided. In one particular embodiment, the stable ceramic anode composition comprises (i) strontium-iron-cobalt-molybdenum oxide material (SFCM); (ii) a first ion-conductor composition comprising an oxide of cerium or cerium that is doped with a rare-earth metal; and (iii) nanoparticles of an electrocatalyst comprising (a) a second ion-conductor and (b) nickel, a nickel alloy, or a combination thereof, wherein said nanoparticles are infiltrated within said porous surface of ceramic anode. Yet in other embodiments, the total amount of said electrocatalyst in said ceramic anode is less than about 10 wt %, typically 8 wt % or less, often about 7 wt % or less, and more often about 5 wt % or less.

In some embodiments, the amount of nickel, nickel alloy, or a combination thereof in the electrocatalyst is less than 50% on an atom basis, typically about 25% or less on an atom basis, often about 20% or less on an atom basis, more often about 15% or less on an atom basis, and most often about 10% or less on an atom basis.

Yet in other embodiments, said second ion-conductor of electrocatalyst comprises an oxide of cerium or cerium that is doped with a rare-earth metal. Still in other embodiments, said nickel alloy in said electrocatalyst comprises cobalt, iron, tin, or a combination thereof.

In one particular embodiment, said electrocatalyst comprises nickel and gadolinium cerium oxide (Ni-GDC). Within this embodiment, in some instances the ratio of nickel to gadolinium cerium oxide in said electrocatalyst is less than about 1:2, typically about 1:4 or less, often 1:6 or less, more often about 1:8 or less, and most often about 1:9 or less.

Still in further embodiments, said SFCM oxide material is of the formula: SrFeₓCo_{((1-x)/2)}Mo_{((1-x)/2)}O_{3±d}, wherein x is 0.1-0.5 and d is 0-1.5. In general, the SFCM oxide material can be any SFCM oxide material that is known to one skilled in the art including, but not limited to, those disclosed in a commonly assigned U.S. Pat. No. 10,938,052, which has previously been incorporated by reference.

In further embodiments, the first ion-conductor composition comprises gadolinium-doped cerium oxide (GDC). In some embodiments, GDC is doped with cobalt. In some instances, the amount of cobalt in said GDC is about 10 wt % or less, typically about 5 wt % or less, and often about 2 wt % or less compared to the amount of GDC.

In general, the stable ceramic anode is not limited to SFCM oxide material. In fact, the scope of the disclosure includes all ceramic anodes known to one skilled in the art, provided that the total amount of nickel or electrocatalyst is within those prescribed herein. Furthermore, the nickel or the electrocatalyst present in the stable ceramic anode should be such that they are present in the surface pores of ceramic anodes. More specifically, nickel or the electrocatalyst should be present as infiltrates of surface pores and should be nanoparticles. One of the key requirements of having a stable ceramic anode is to provide electrocatalyst or nickel infiltrates at a sufficiently low enough concentration to allow a long-term operation of the anode without cracking or diminishing its performance, e.g., cell voltage.

Another aspect of the disclosure provides stable SFCM anode-supported SOFC. In some embodiments, stable SFCM anodes of the invention operate efficiently in low-temperature range, e.g., less than about 800° C., typically about 750° C. or less, often about 700° C. or less, more often about 650° C. or less, and most often 600° C. or less.

In some embodiments, the first ion-conductor composition comprises an oxide of cerium or cerium that is doped with a rare-earth metal. Exemplary rare-earth metals include yttrium, scandium, and the lanthanide metals. In some embodiments, ion-conductor composition comprises a lanthanide metal comprising Gd, Pr, Nd, Sm, Y, La, Eu, Tb, Dy, Ho, Er, Tm, Yb, or a combination thereof. In one particular embodiment, said lanthanide metal comprises Gd, Pr, Nd, Sm, or a combination thereof.

Still, in other embodiments, the ratio of SFCM to said first ion-conductor composition ranges from about 5:1 to about 1:1 by weight, typically from about 4:1 to about 3:1 by weight, and often from about 2:1 to 1:1 by weight. In one specific embodiment, the ratio of SFCM to said first ion-conductor composition is about 2:1 by weight.

In further embodiments, a surface of said ceramic anode composition is porous. This porosity allows infiltration of said electrocatalyst on the surface of the stable ceramic anode.

The average pore size of the ceramic anode surface can range from about 5 μm to about 10 μm. However, it should be appreciated that the scope of the present disclosure is not limited to these particular average pore size. In fact, any pore size that is sufficient to accommodate the electrocatalyst can be used. In general, however, the pore size on the surface of the ceramic anode composition should be sufficiently large enough to accommodate the electrocatalyst but sufficiently small enough to prevent dislodging of the electrocatalyst.

As discussed herein, in some embodiments, the ceramic anode composition of the disclosure also includes nanoparticles of the electrocatalyst. The electrocatalyst is infiltrated within the pores of the ceramic anode surface. As used herein, the term “infiltrated” refers to putting the electrocatalyst inside the pores, typically as a liquid precursor, and calcinating or heating the resulting composition. Typically, the electrocatalyst occupies the pore spaces on the surface of the ceramic anode. One can place the electrocatalyst within the pores of the ceramic anode using any of the methods known to one skilled in the art. One particular example is to dissolve the electrocatalyst in a solvent and allow the solution to penetrate the pores and remove the solvent, e.g., by drying using heat and/or vacuum, or simply by letting the solvent evaporate. In some embodiments, the electrocatalyst is a nanoparticle such that it infiltrates the surface pores of the ceramic anode. Generally, the average particle size of nickel in the electrocatalyst is about 200 nm or less, typically about 100 nm or less, often about 75 nm or less, and most often about 50 nm or less. In some instances, the total amount of the electrocatalyst is less than about 10 wt % or less, typically less than about 8 wt %, often about 7.5 wt % or less, more often about 5 wt % or less, and most often less than about 5% relative to a total amount of said ceramic anode composition. Yet in other embodiments, the electrocatalyst comprises a nickel alloy. In some instances, nickel alloy comprises cobalt, iron, tin, or any other transition metal, or a combination thereof.

In further embodiments, the second ion-conductor comprises an oxide of cerium or cerium that is doped with a rare-earth metal. In one particular embodiment, the second ion-conductor is gadolinium-doped cerium oxide (GDC).

In one specific embodiment, the electrocatalyst comprises nickel-gadolinium cerium oxide (Ni-GDC). Yet in other embodiments, the electrocatalyst or nickel in said electrocatalyst has a particle size of about 200 nm or less, typically 100 nm or less, often 75 nm or less, and most often 50 nm or less. Without being bound by any theory, based on extensive research by the present inventors, one of the reasons for the failure of anodes in SOFCs is due to the change in the size of nickel that is present in the electrocatalyst during its operation. In particular, it is believed the particle size of nickel when combined with oxygen to form nickel oxide increases and when it is reduced to nickel the particle size is reduced. Still in other instances, the present inventors have observed nickel agglomeration leading to large nickel particles during operation can lead to SOFC failures. This expansion and reduction and/or agglomeration of nickel during SOFC operation is believed to be one of the main reasons that creates cracks, and hence failure, of anodes as well as decreased efficiency. As used herein, the terms “decreased efficiency” and “decreased performance” are used interchangeably herein and refer to the reduction of cell voltage in galvanostatic mode testing over a period of 200 h of about 10% or more, typically about 15% or more, and often 20% or more.

As stated above, at a certain nickel concentration, when infiltrated nickel particles are close together, operation of SOFC leads to formation of nickel agglomerates, thereby increasing the likelihood of anode failure and decreased anode performance or efficiency. Accordingly, to reduce the likelihood of agglomerate formation, the amount of nickel present in Ni-GDC, or other electrocatalyst with nickel, is less than about less than 50% on an atom basis, typically about 25% or less on an atom basis, often about 20% or less on an atom basis, more often about 15% or less on an atom basis, and most often about 10% or less on an atom basis. Still in other embodiments, the ratio of Ni to GDC in the electrocatalyst is about 1:2 or less on an atom basis, typically about 1:3 or less on an atom basis, often about 1:4 or less on an atom basis, more often about 1:5 or less on an atom basis, still more often 1:7 or less on an atom basis, and most often about 1:9 or less on an atom basis. Still in some embodiments the amount of nickel present in Ni-GDC is such that even after 200 h of operation under galvanostatic mode the change in the particle size of nickel using SEM (i.e., initial vs. 200 h) is less than about 25%, typically less than about 20%, often less than about 15%, more often less than about 10%, still more often less than about 5%, and most often less than about 2%.

Yet in other embodiments, said first ion-conductor composition in the ceramic anode comprises gadolinium-doped cerium oxide (GDC), i.e., the ceramic anode composition comprises SFMC-GDC. In some instances, said GDC of ion-conductor composition is doped with cobalt. While the amount of cobalt can vary, in one particular embodiment, the amount of cobalt in said GDC is about 10 wt % or less, typically about 5 wt % or less, and often about 2 wt % or less.

Other aspects of the disclosure provide a solid oxide fuel cell (SOFC) comprising: (a) a cathode layer; (b) a stable ceramic anode layer having a less than 15% cell voltage reduction in galvanostatic mode over a period of 200 h; and (c) an electrolyte layer located between said cathode layer and said ceramic anode layer. In one particular embodiment, the stable ceramic anode layer comprises strontium-iron-cobalt-molybdenum (SFCM) and (ii) the first ion-conductor composition comprising an oxide of cerium or cerium that is doped with a rare-earth metal. In one particular embodiment, the first ion-conductor composition of said ceramic anode layer comprises gadolinium-doped cerium oxide.

Still, in other embodiments, the ceramic anode layer of the SOFC comprises a porous surface containing nanoparticles of an electrocatalyst. In some instances, the electrocatalyst comprises Ni-GDC. The amount of nickel relative to GDC in Ni-GDC is less than about 50% on an atom basis, typically about 40% or less on an atom basis, often about 30% or less on an atom basis, more often about 20% or less on an atom basis, and most often about 10% or less on an atom basis.

In further embodiments, the amount of electrocatalyst in the stable ceramic anode is less than 10 wt %, typically about 8 wt % or less, typically about 7 wt % or less, and often about 5 wt % or less.

Yet in other embodiments, the solid oxide fuel cell further comprises a cathode functional layer (CFL) located between said cathode layer and said electrolyte layer. In some instances, said CFL comprises cobalt-doped GDC (Co-GDC). Without being bound by any theory, it is believed that the CFL increases the active area for oxygen reduction and charge transfer through the cathode/electrolyte interface, thereby improving performance of SOFC. In addition, it is believed that the presence of CFL also increases the stability of the cathode from thermal stresses during SOFC operation.

Still, in other embodiments, the surface of said ceramic anode layer is infiltrated with nanoparticles of nickel gadolinium-cerium oxide. Surface modification of conductive ceramic anodes using nanostructured electrocatalysts, e.g., infiltration of nanoparticles of electrocatalyst to the ceramic anode, is a facile approach to introduce catalytic activity which in turn can make them appropriate for LT-SOFCs. Nanoscale surface modifications using an electrocatalyst offers a variety of advantages including, but not limited to, suppressing carbon formation or coking when a hydrocarbon-based fuel, such as CH₄, propane, an alcohol, etc. is used as a fuel source, enhancing fuel tolerance to sulfur, and facilitating oxidation of hydrocarbon fuels at lower temperatures, as well as providing other advantages. In addition, the porous ceramic support structures allow expansion and contraction of nanosized Ni, thereby preventing failure of Ni-GDC supported cells during a long-term operation or due to redox cycling instability.

In some aspects of the disclosure, a stable SFCM (e.g., SrFe_{0.2}Co_{0.4}Mo_{0.4}O₃) ceramic anode that is infiltrated with nanoparticles of Ni-GDC is used instead of conventional Ni anodes to provide LT-SOFCs. SFCM-anode supported SOFC has shown to be stable over a number of redox cycles with a high open circuit voltage (OCV) of 0.89 V and a peak power density (PPD) of 500 mW/cm² at 600° C. in H₂/3% H₂O. Detailed study by the present inventors also revealed that oxygen non-stoichiometry of SFCM compensates for the dimensional changes during redox cycles. Without being bound by any theory, it is believed that the dimensional changes during redox cycles can result in the formation of cracks in conventional nickel or Ni-cermet anodes, thereby leading to SOFC failure. In examples of the present disclosure, ceramic anodes comprising SFCM infiltrated with a limited amount of nanoparticles of nickel or electrocatalyst have shown to be superior anodes for LT-SOFC technology.

Fuel flexibility is a unique feature of SOFCs. The instability of conventional Ni-based cermet anodes in hydrocarbon fuels has thus far impeded the advancement of low-temperature solid oxide fuel cells (LT-SOFCs). The present inventors have demonstrated that in some embodiments, highly stable LT-SOFCs prepared by catalytically modifying the surface of a conductive ceramic oxide, e.g., SFCM, using nanoparticles of electrocatalyst, can readily overcome many limitations of conventional Ni-based cermet anodes. In some embodiments, the nano-sized Ni-GDC electrocatalysts, resulting from Ni-to-GDC ratio disclosed herein, and subsequent low-temperature calcination process, enhance the fuel oxidation kinetics and stability of SFCM anode significantly. For example, an electrocatalyst with Ni-to-GDC ratio of 1:9 on SFCM-supported SOFC can deliver peak power density of about 0.60 W/cm² or higher, typically about 0.65 W/cm² or higher, often about 0.70 W/cm² or higher, and most often about 0.75 W/cm² or higher at 650° C. in humidified H₂. In other embodiments, a Ni-to-GDC ratio of 1:9 on SFCM-supported SOFC can deliver peak power density of about 0.50 W/cm² or higher, typically about 0.55 or W/cm² higher, often about 0.60 W/cm² or higher, and most often about 0.65 W/cm² or higher at 600° C. in humidified Hz. Yet in other embodiments, a Ni-to-GDC ratio of 1:9 on SFCM-supported SOFC can deliver peak power density of about 0.20 W/cm² or higher, typically about 0.25 or W/cm² higher, often about 0.30 W/cm² or higher, and most often about 0.35 W/cm² or higher at 550° C. in humidified H₂.

In further embodiments, in CH₄/H₂ gas mixtures as an example of hydrocarbon gas performance, a Ni-to-GDC ratio of 1:9 on SFCM-supported SOFC can deliver peak power density of about 0.45 W/cm² or higher, typically about 0.50 W/cm² or higher, often 0.55 W/cm² or higher and most often about 0.60 W/cm² or higher at 650° C. Yet in other embodiments, under this gas mixture, a Ni-to-GDC ratio of 1:9 on SFCM-supported SOFC can deliver peak power density of about 0.25 W/cm² or higher, typically about 0.30 W/cm² or higher, often 0.35 W/cm² or higher, and most often about 0.40 W/cm² or higher at 600° C. Still in other embodiments, under this gas mixture a Ni-to-GDC ratio of 1:9 on SFCM-supported SOFC can deliver peak power density of about 0.10 W/cm² or higher, typically about 0.15 W/cm² or higher, often about 0.20 W/cm² or higher, and most often about 0.25 W/cm² or higher at 550° C.

Surprisingly and unexpectedly, stable ceramic anodes comprising nanoparticles of infiltrated electrocatalyst (e.g., Ni-GDC) can maintain a stable cell voltage of 0.82V over at least about 100 h, typically over at least 150 h, often over at least 200 h, still more often over at least 250 h, and most often over at least 300 h of operations (under current) at 600° C. in CH₄/H₂ gas mixtures. As used herein, the term “stable” refers to maintaining cell voltage within about 15%, typically within about 10%, often within about 5%, and most often within about 3% of the initial cell voltage.

Additional objects, advantages, and novel features of this invention will become apparent to those skilled in the art upon examination of the following examples thereof, which are not intended to be limiting. In the examples, procedures that are constructively reduced to practice are described in the present tense, and procedures that have been carried out in the laboratory are set forth in the past tense.

### EXAMPLES

Example 1: SFCM-GDC anode vs. Ni-GDC Anode: This example shows comparative examples of SFCM-GDC anode vs. Ni-GDC anode.

SFCM Synthesis: SFCM was prepared by a conventional solid-state synthesis route. Stoichiometric amounts of strontium carbonate (SrCO₃, Sigma-Aldrich), iron oxide (Fe₂O₃, Sigma-Aldrich), cobalt oxide (Co₂O₃, Inframat-Advanced Materials), and molybdenum oxide (MoO₃, Alfa Aesar) were ball-milled in ethanol medium for 24 h. The resulting mixed oxides were then dried in an oven to evaporate ethanol. The dried powder was heat-treated at 1100° C. for 4 h. The phase purity was determined using a Bruker D8 powder X-ray diffractometer (XRD) with Cu Kα radiation. The XRD data show a pure perovskite phase.

Fabrication of Ni-GDC Anode-Supported SOFCs: Ni-GDC anodes for comparison with the SFCM-GDC anode were prepared using a tape-casting method. The tape-casting recipe for the Ni-GDC anode-supported SOFC constitute ethanol (solvent), Menhaden fish oil (dispersant), polyvinyl butyral (PVB; binder), benzyl butyl phthalate, and BBP (plasticizer). The SOFC configuration comprises 30 μm-thick GDC tape laminated with NiO-GDC anode functional layer (AFL) tape and NiO-GDC anode-support layers (ASLs). The lamination was performed using a hydraulic hot press. The laminated tapes were stepwise heat-treated to burn out organic binders and sintered at 1450° C. for 4 h. The resulting half-cell consisted of a 550 μm-thick porous NiO-GDC ASL scaffold and an ˜20 μm dense GDC electrolyte. The LSCF-GDC cathode was then deposited and sintered at 1100° C. for 2 h to form the full SOFC button cells.

Fabrication of Ceramic Anode-Supported SOFCs: An anode-supported SOFC configuration was used with an anode support consisting of a SFCM-GDC composite in a weight ratio of 2:1. GDC used in making the SFCM-GDC composite anode was separately doped with 2 mol % Co₂O₃ to adjust the shrinkage mismatch with the electrolyte. A cathode functional layer (CFL) consisting of 2 wt % Co-modified GDC (Co-GDC) was applied between the Sm_{0.5}Sr_{0.5}CoO₃-GDC (SSC-GDC) cathode and GDC electrolyte.

The tape-casting method was used to prepare the porous SFCM-GDC scaffold. The tape-casting recipe constitutes 80% ethanol as the solvent, 1.6% Menhaden fish oil as the dispersant, 17.6% polyvinyl butyral (PVB) as the binder, 10% benzyl butyl phthalate (BBP) as the plasticizer, and poly(methyl methacrylate) (PMMA) as the pore-former (16 wt %). All percentages are relative to the SFCM-GDC solid content. For making dense GDC tape, the 30 μm thick as prepared GDC tape was laminated with prelaminated SFCM-GDC sheets using a hot press. The laminated tapes were stepwise heat treated to burn out the PMMA pore formers and an organic binder followed by sintering at 1200° C. for 4 h. The resulting half-cell consists of a porous SFCM-GDC scaffold and an ˜20 μm dense GDC electrolyte. The prepared half-cell was then deposited (doctor-blade method) with the CFL and dried in an oven (100° C.) for 2 h followed by deposition of the SSC-GDC cathode. The assembly was then sintered at 950° C. for 2 h. Compared to conventional high-temperature sintering for Ni-GDC-based cells (˜1450° C.), the entire processing of SFCM-based cells requires a relatively low sintering temperature of 1200° C. in air, reducing cost and process complexities.

Infiltration of Ni-GDC Nanoparticles: The prepared anode-supported full cells were then infiltrated with the NiO-GDC precursor on the anode side. The required quantity of NiO-GDC (Ce_{0.9}Gd_{0.1}O_{2-δ}) precursor was prepared by dissolving nitrates of nickel, cerium, and gadolinium (Alfa Aesar) in H₂O. A few drops of the infiltrate solution were added on the porous scaffold of samples. The samples were then kept under vacuum for 10 min. Between each successive infiltration step, the sample was heat-treated at 400° C. for an hour to decompose the nitrates. The infiltration cycles were repeated to get an approximate loading of ˜10 wt % in all the samples.

Electrochemical Measurements: I-V characteristics and power densities of SOFCs were determined using Solartron 1470E. Electrochemical impedance spectroscopy (EIS) was performed using a Solartron 1425 frequency response analyzer. The electrochemical performance including I-V characteristics and impedance spectra was determined using a fuel cell testing fixture loaded with the SOFC. A commercial two-part sealant (ceramabond-517, Aremco) was used to separate the anode and cathode compartments. The anode and cathode side of the cells were exposed to 100 mL/min of humidified H₂ and synthetic air, respectively. The active area of the fuel cell was 0.31 cm². Gold wires and silver paste were used as leads and the current collector, respectively, for all the SOFCs characterized in this study.

Scanning electron microscopy (SEM) of the post-tested SOFCs was performed using a Hitachi SU-70 with a field-emission gun equipped with a Bruker XFlash silicon drift EDS detector.

Results and Discussion

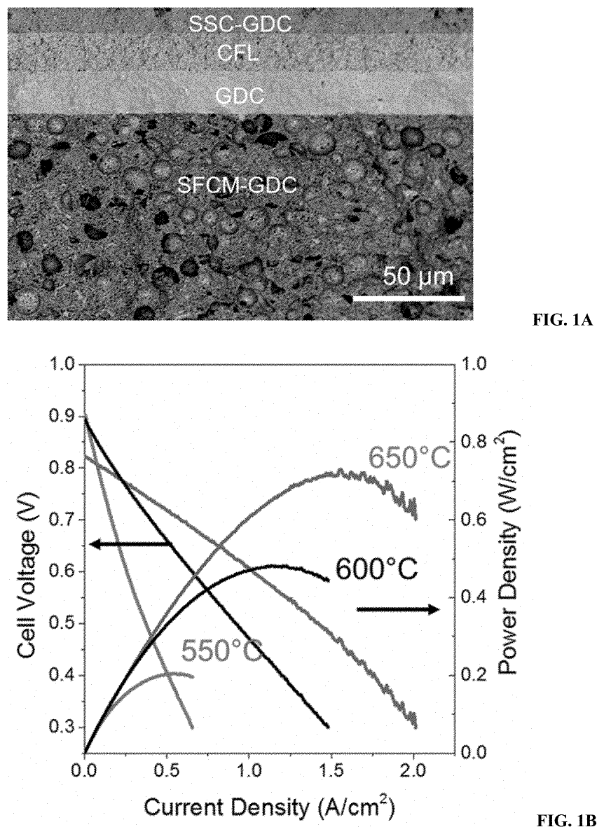

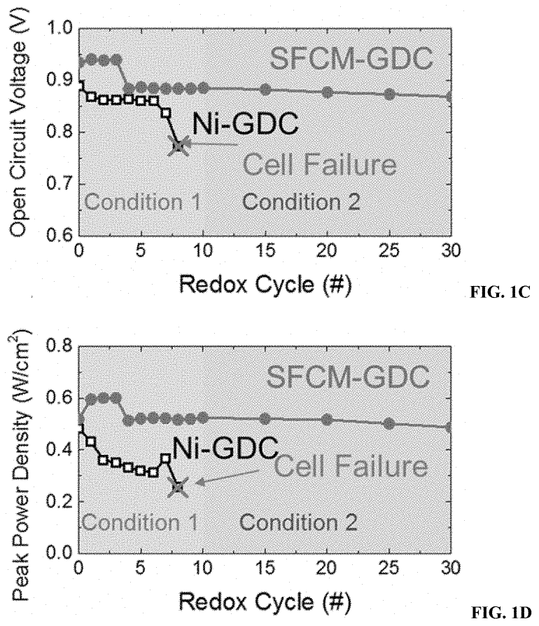

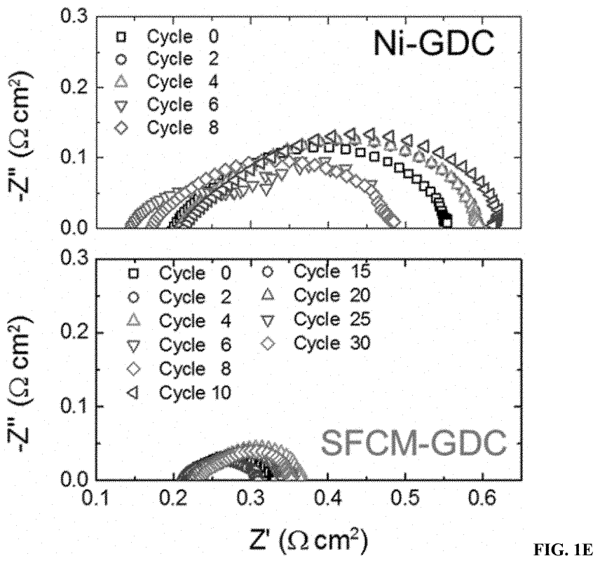

The performance of Ni-GDC-infiltrated SFCM-GDC anodes was investigated using the anode-supported SOFC configuration (porous anode support|electrolyte|cathode functional layer (CFL)|cathode). FIG. 1A shows the SEM micrograph of the SOFC structure under investigation. The SOFC configuration consists of a porous SFCM-GDC anode support with a 20 μm dense GDC electrolyte and a 20 μm CFL followed by a 12 μm porous SSC-GDC cathode. FIG. 1B shows the initial performance of the SOFC at 650, 600, and 550° C. using H₂/3% H₂O and air at the anode and cathode, respectively. The OCV values are 0.82, 0.89, and 0.91 V at 650, 600, and 550° C., respectively. The OCV values are on par with the predicted values for a 20 μm-thick GDC-based SOFC. Peak power densities (PPDs) of 730, 500, and 200 mW/cm² at 650, 600, and 550° C., respectively, were achieved, which are much higher than the previously reported values for Sr₂Fe_{1.5}Mo_{0.5}O_{6-δ}-GDC (220 and 140 mW/cm² at 700 and 600° C.) and La_{0.75}Sr_{0.25}Cr_{0.5}Mn_{0.5}O_{3-δ}-SDC (365, 196, and 94 W/cm² at 650, 600, and 550° C.)-based ceramic anode-supported SOFCs with a doped-ceria electrolyte. Further, a PPD value of 730 mW/cm² at 650° C. for SFCMGDC (in this study) is comparable to Ni-GDC anode-supported cells (e.g., 560 mW/cm² at 650° C.) reported in the literature.

The SOFC under investigation was treated under two different conditions, as shown in FIGS. 1C, 1D, and 1F. For condition 1, the performance was measured after each redox cycle carried out under open circuit conditions. For condition 2, the performance was measured after each series of five redox cycles under an operating current (0.2 A/cm²). FIG. 1C shows the plot of OCV versus the number of redox cycles for the SFCM-GDC anode-supported cell with a direct comparison to that of Ni-GDC. Each redox cycle in condition 1 corresponds to a period of 20 min in N₂ followed by H₂, while each redox cycle in condition 2 corresponds to 5 min in N₂ followed by H₂.

Although the OCV of the SFCM-GDC cell decreased slightly after the third redox cycle, it remained stable up to 30 cycles in both conditions. In contrast, the OCV of the Ni-GDC cell gradually decreased throughout seven cycles and at the eighth cycle the OCV decreased to 0.75 V, indicating initiation of cell failure. FIG. 1D illustrates the PPD of SOFCs versus the number of redox cycles; the PPD of the SFCM-GDC cell has a similar trend to the OCV with good stability after the third redox cycle. In contrast, the PPD of Ni-GDC shows a gradual decrease in performance, and a very low PPD of 250 W/cm² is observed at the eighth cycle due to cell failure.

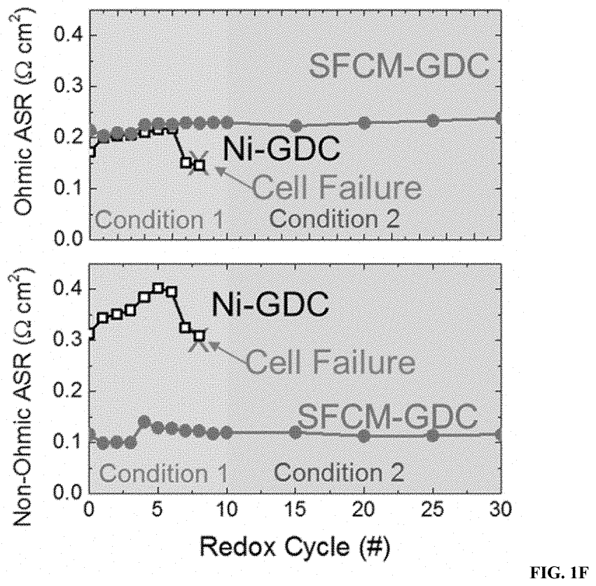

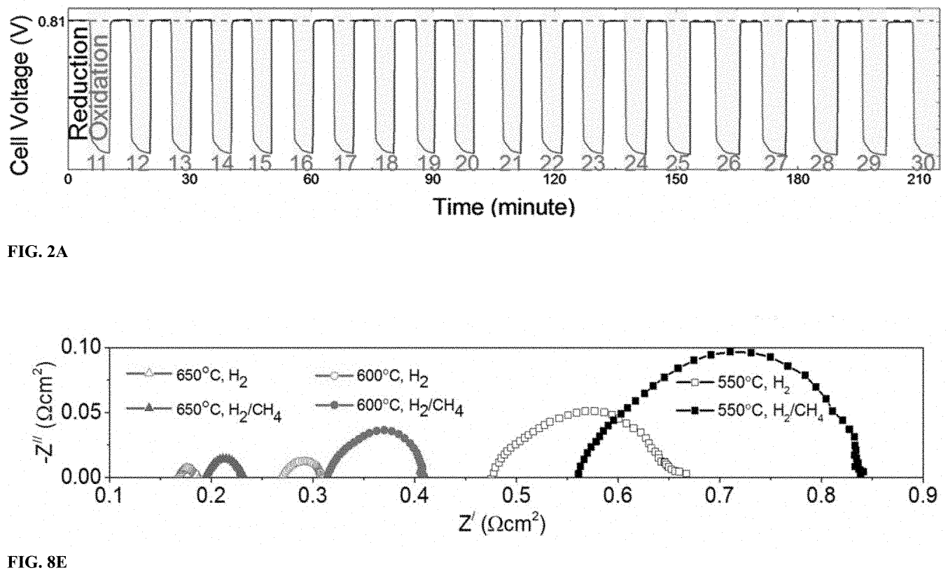

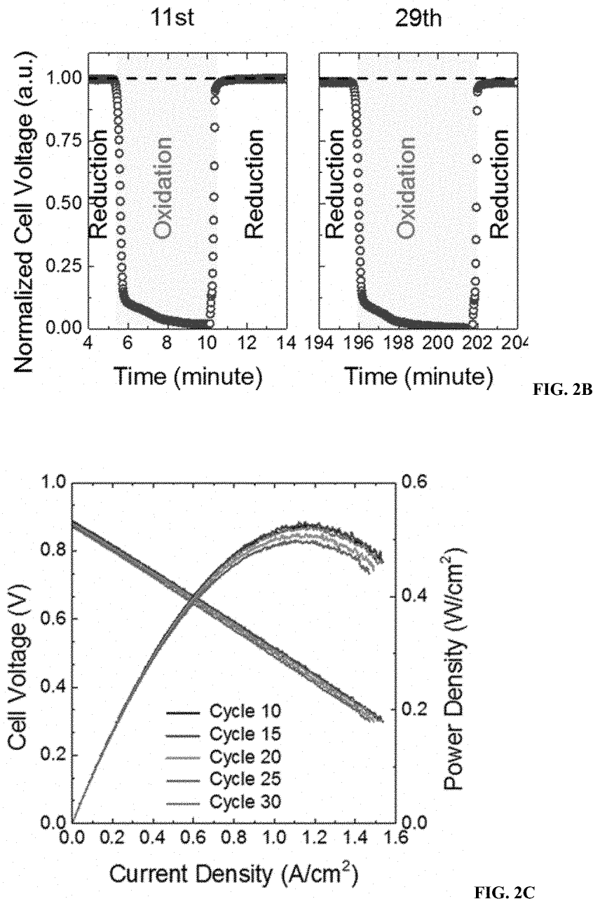

SFCM-GDC has been successfully demonstrated herein to survive high-temperature sintering processes in air and is compatible with the low-temperature GDC electrolyte. SFCM provides the necessary high electronic conductivity otherwise provided by Ni and is the first to demonstrate redox stability at the full cell level. SFCM does not, however, have the catalytic activity toward hydrogen oxidation that Ni does, particularly for low-temperature SOFC operation (<600° C.). However, SFCM can provide a stable scaffold with the required electronic conductivity and the infiltrated nano-Ni-GDC particles can then provide the required catalytic activity, resulting in stable high-performance SFCM-GDC-based anode-supported cells. EIS was performed on both Ni-GDC and SFCM-GDC cells. FIG. 1E presents the Nyquist plots of Ni-GDC and SFCMGDC cells, and the impedance spectra of Ni-GDC shows a much higher ASR than those of SFCM-GDC. The variations in ohmic and nonohmic ASR of the SFCM-GDC and Ni-GDC cell are presented in FIG. 1F. Both ohmic and nonohmic ASR of the SFCM-GDC cell decrease until three redox cycles, causing an improvement in PPD; however, after the third cycle, the ohmic ASR increases slightly (especially in condition 2) due to Ni agglomeration, decreasing the connectivity for electronic conduction but is compensated for by the decrease in nonohmic ASR, providing a relatively stable PPD throughout 30 redox cycles in both conditions. To simulate redox cycles due to fuel-rich and fuel-starved conditions, the gas environment at the anode side of the SFCM-GDC cell was cycled between N₂ and H₂ under a load for five cycles. FIG. 2A shows the SFCM-GDC cell voltage as a function of time under multiple redox cycles under a constant current load of 0.2 A/cm². The cell has a constant cell voltage of ˜0.81 V, and there is no detectable degradation even after 30 redox cycles (10-30 cycling durations under a load). The enlarged views of the 11th and 29th redox cycle are shown in FIG. 2B. Voltage relaxation curves show identical shapes at each redox cycle, suggesting that the cell is robust and the degradation due to cycling is insignificant. Asymmetrical relaxation curves were also observed during reduction and oxidation, which are reversible under the tested period of 30 redox cycles (10-30 cycling durations under a load). The performance of the cell at every five cycles is shown in FIG. 2C. The cell shows a stable PPD of 500 W/cm² at 600° C. and an OCV of 0.89 even after 30 redox cycles, as summarized in FIG. 1D, condition 2.

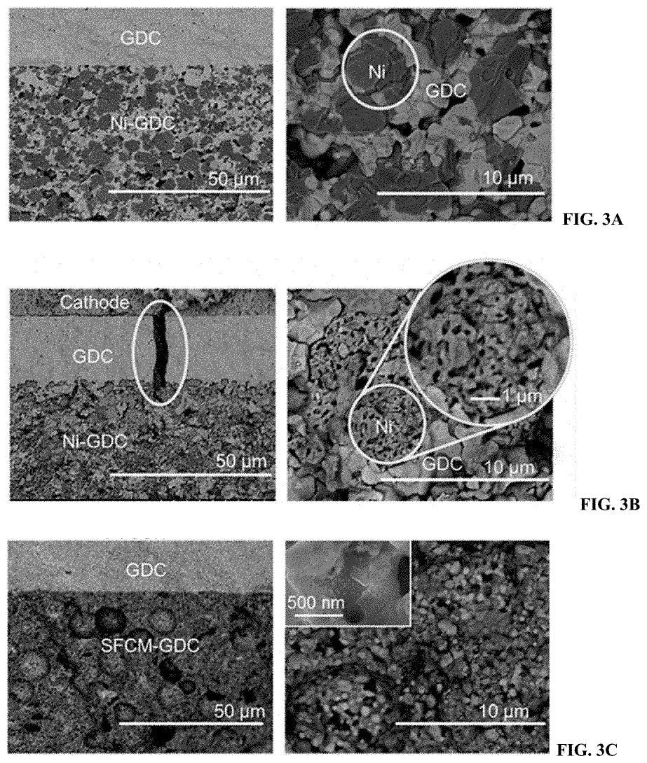

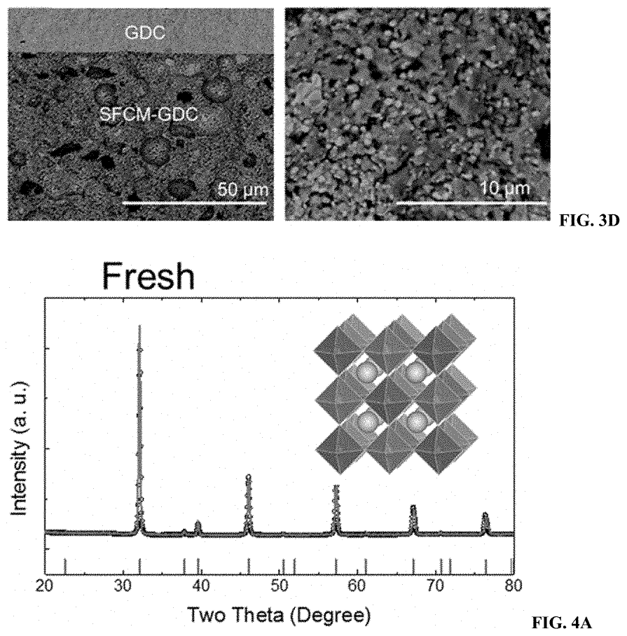

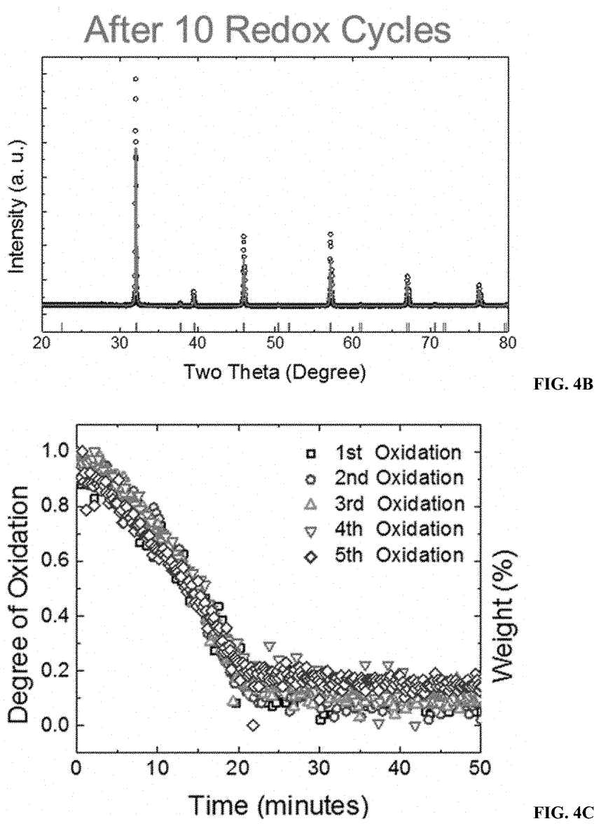

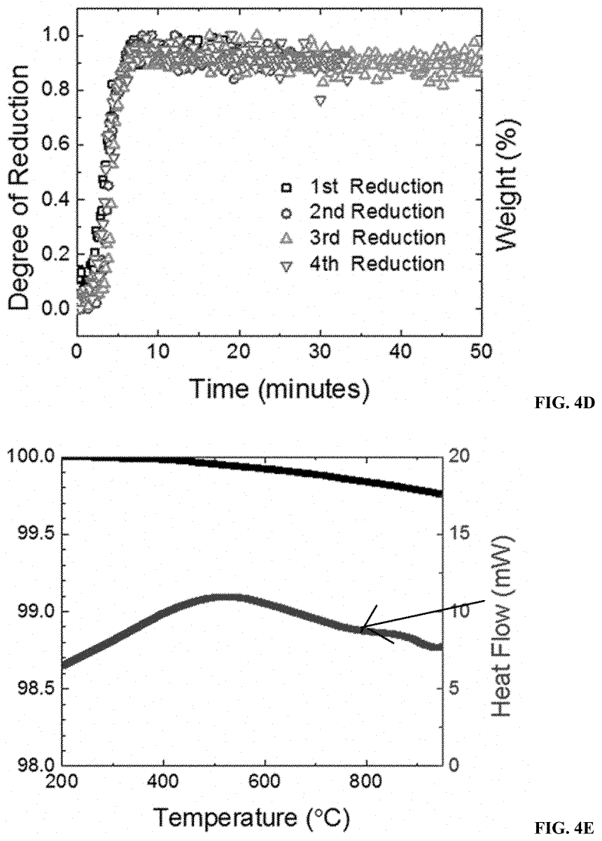

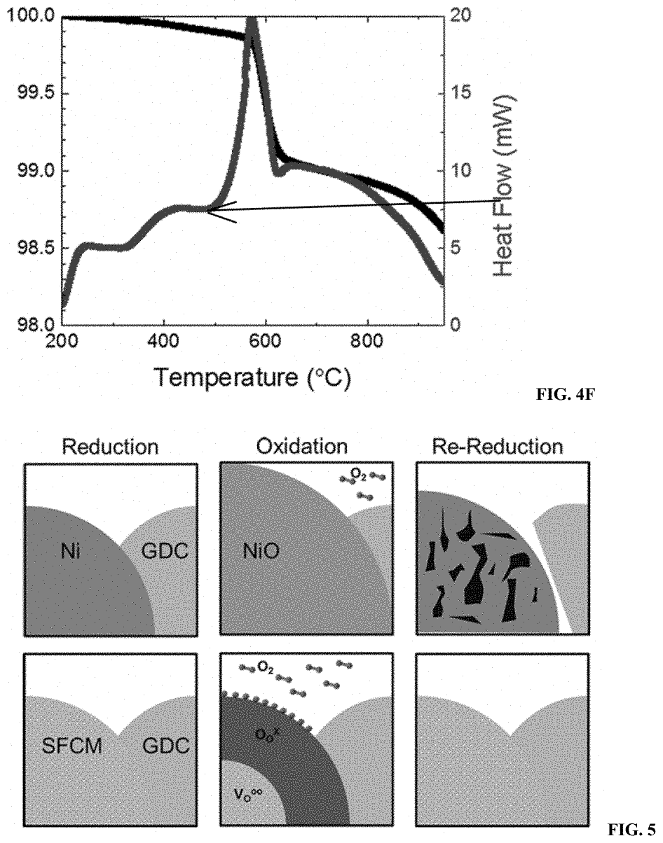

FIGS. 3A-3D show SEM micrographs of Ni-GDC- and SFCMGDC-based cells before/after cycling. FIG. 3A shows a fresh Ni-GDC cell before any testing. The large dimensional change in Ni induces cracks along the Ni particles after eight redox cycles, and the honeycomb-shaped Ni particles appear, as shown in FIG. 3B. FIGS. 3C and 3D show the microstructure of a fresh and post-redox-cycled SFCM-GDC cell, and no difference in the microstructure is observed. Ni-GDC is the state-of-the-art anode for low-temperature SOFCs that provide high catalytic activity. However, the redox instability due to the huge volume change between Ni and NiO makes it incompatible as a structural component of a Ni-GDC anode. In contrast, Ni-GDC nanoparticles were dispersed on an SFCM structural support that does not expand/contract upon cycling. A higher-magnification SEM image, FIG. 3C inset, clearly shows Ni-GDC nanoparticles on the SFCM surface. In comparison to bulk Ni-GDC, the SFCM-GDC cell shows robust dimensional stability, and there are no observable changes even after 30 redox cycles. The phase purity of SFCM after redox cycles was determined by X-ray diffraction (XRD). Rietveld refinement on XRD of fresh and redox-cycled samples suggests that SFCM has the same crystal structure as the pristine SFCM, as shown in FIGS. 4A and 4B. There are no detectable secondary phases even after 10 redox cycles. The dimensional changes in SFCM were determined by a dilatometer. Table 1 summarizes the changes in ΔL/L (where ΔL is the change in the length and L is the original length) of SFCM after different numbers of redox cycles. The dimensional variation of SFCM between the oxidation (air, pO₂=0.21 atm) and reduction state (10% H₂/N₂) is only 0.16-0.17%. This small dimensional change minimizes the induced chemical-mechanical stress, providing remarkable mechanical stability under different gas environments. Relaxation curves for dimensional changes of SFCM during oxidation and reduction at each cycle are shown in FIGS. 4C and 4D, respectively. The relaxation curves are identical after five redox cycles, suggesting that SFCM has high stability. The asymmetrical relaxation curves during oxidation and reduction suggest that the oxidation and reduction process are governed by different reaction mechanisms. The redox kinetics of SFCM show an asymmetric transport behavior; the oxidation takes about 30 min to reach equilibrium, while the reduction only takes less than 5 min. The release of oxygen from the SFCM lattice is significantly faster than that in the reoxidation process. The oxidative relaxation curve cannot be fit using surface exchange and diffusion co-limited equations, suggesting that the surface oxidation process may be co-limited by other factors. A possible mechanism for the slow changes during oxidation is the ordering of incorporated oxygen or a phase transition in SFCM. TGA was performed on SFCM powder to identify weight changes as a function of temperature and pO₂. FIGS. 4E and 4F show the TGA and DSC curves in air and 5% H₂, respectively. The total weight change in air from room temperature to 950° C. is less than 0.3%. In contrast, SFCM in 5% H₂ shows a rapid weight change accompanied by the change in heat flow around 600° C., possibly due to a rapid oxygen loss. Dilatometer measurement shows that the dimensional changes of SFCM in different gases are about 0.1%, while the weight change between air and 5% H₂ is about 1%. This difference suggests that SFCM has a robust structure. SFCM can maintain its structure with oxygen loss or gain without inducing a significant dimensional change.

TABLE 1
Summary of the percentage changes in ΔL/L
of SFCM after redox cycles.

| | ΔL/L (%) | | | | |
|---|---|---|---|---|---|
| pO₂ | 1^{st} | 2^{nd} | 3^{rd} | 4^{th} | 5^{th} |
| 0.21 | 0 | 0.04 | 0.06 | 0.06 | 0.05 |
| H₂ | 0.12 | 0.17 | 0.17 | 0.17 | 0.16 |

FIG. 5 illustrates different possible redox reaction mechanisms on Ni-GDC and SFCM-GDC. When Ni-based anodes are exposed to the oxidizing gas environment, Ni is oxidized to NiO with a cumulative redox strain in the range of 0.25-3.2% (depending on the operation temperature and test conditions). Upon subsequent exposure to the reducing environment, the shrinkage of NiO due to reduction leads to irreversible dimensional changes (approximately 1%), resulting in crack and/or delamination of the electrolyte and formation of honeycomb-like Ni particles with constricted pores. In contrast, on exposing the SFCM-GDC cell to an oxidizing gas environment, SFCM changes lattice oxygen vacancy concentrations, forming different levels of non-stoichiometry. Meanwhile, exposing it back to the reducing environment, SFCM attains a steady state with the reducing gas and releases lattice oxygen. This process is reversible and is not affected by the number of redox cycles with and without a load. Therefore, SFCM-GDC remains intact even after redox cycles, exhibiting its excellent robustness.

Conclusion: Experimental results suggest that SFCM based ceramic oxide is a unique, redox stable anode-material for LT-SOFCs. Further, SFCM-GDC cells show robust SOFC operation after 30 redox cycles under load at 600° C. in H₂/3% H₂O. Unlike the commonly used Ni-GDC, ceramic anodes retained the dimensional stability and microstructure as that of pristine SFCM-GDC even under harsh cycling conditions. Oxygen stoichiometry of ceramic SFCM plays an important role in maintaining the dimensional stability after multiple redox cycles. The excellent redox stability and performance of SFCM based ceramic anode-supported cell makes it an excellent replacement for Ni based LT-SOFC anodes. The surprising and unexpected dimensional stability and performance of SFCM ceramic anode is viewed as significant progress towards replacement of Ni anode, which provides access to LT-SOFC technology.

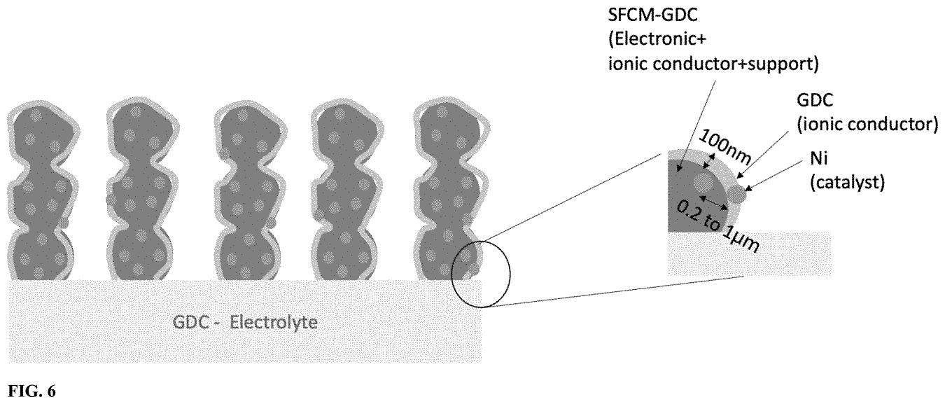

Example 2: SFCM-GDC anode with infiltrated second ion-conductor composition: This example shows stability of SFCM ceramic anode having Ni-GDC nanoparticle infiltrates on its surface. This embodiment is schematically illustrated in FIG. 6. In particular, FIG. 6 shows a representative GDC coating thickness in the anode and distance between Ni—Ni particles.

Synthesis and characterization of SFCM: SFCM was prepared by conventional solid-state synthesis method. Stoichiometric amounts of strontium carbonate (SrCO₃, Sigma-Aldrich), iron oxide (Fe₂O₃, Sigma-Aldrich), cobalt oxide (Co₂O₃, Inframat-Advanced Materials) and molybdenum oxide (MoO₃, Alfa-Aesar) were ball-milled in an ethanol medium for 24 h. The resulting mixed oxides were then dried in an oven to evaporate the ethanol. The dried powder was heat-treated at 1100° C. for 4 h. The phase purity was determined using a Bruker D8 powder X-ray diffractometer (XRD) with Cu Kα radiation.

DC electrical conductivity of SFCM was measured on a bar sample (length=7.5 mm, width=2.8 mm and height=1.6 mm). The bar sample was prepared by compacting SFCM powder using a rectangular die and sintered at 1350° C. for 4 h in air. The density of the sintered sample is 96%, determined by Archimedes' principle using Mettler Toledo's Density measurement apparatus. For DC conductivity measurements using Keithley 2400 source meter, silver wires and paste were used as leads and current collector, respectively. The sample was placed in a reactor that operated under a controlled gas environment. The samples were first heated up to 650° C. in humidified 10% H₂/N₂ (pure H₂ was not used for safety considerations) and kept overnight under the reducing gas conditions. Before taking measurements, 30 min stabilization time was provided at each interval and electrical measurements were made at 50° C. intervals down to 400° C.

Anode-supported SOFCs electrochemical characterization: An anode-supported electrolyte configuration was used to determine the SOFC characteristics. The anode support consisted of SFCM-GDC composite in the weight ratio of 2:1. SFCM-GDC composites are used for the anode to increase the triple phase boundary (TPB) length and help match the thermal expansion coefficient between the anode and GDC electrolyte. Further, GDC of the SFCM-GDC composite was doped with Co (2 mol. % cobalt oxide) to adjust the rate of shrinkage. A cathode functional layer (CFL) consisting of Co-modified GDC (Co-GDC) was used at the interface of Sm_{0.5}Sr_{0.5}CoO₃-GDC (SSC-GDC) cathode and GDC electrolyte.

The tape-casting method was used to prepare the porous SFCM-GDC scaffold. Tape-casting recipe constituted 80% ethanol as solvent, 1.6% Menhaden fish oil as dispersant, 17.6% polyvinyl butyral (PVB) as binder, 10% benzyl butyl phthalate (BBP) as a plasticizer and poly (methyl methacrylate), PMMA as pore-former (16 wt. %). All percentages are relative to the SFCM-GDC solid content. The recipe was cast as a film of thickness 110 μm on a Mylar sheet and laminated using a hot press to achieve the desired thickness. Dense GDC tape was then laminated with already pre-laminated SFCM-GDC sheets using the hot press. The laminated tapes were stepwise heat-treated to burn out the PMMA pore-formers and an organic binder, followed by sintering at 1200° C. for 4 h. The half-cell that resulted consisted of the porous SFCM-GDC scaffold and ˜20 μm-thick dense GDC electrolyte. The prepared half-cell was then deposited (doctor-blade method) with Co-GDC cathode functional layer and dried in an oven (100° C.) for 2 h, followed by deposition of SSC-GDC cathode. The assembly was then sintered at 950° C. for 2 h. Co-GDC and SSC-GDC were formulated as screen printing ink using Thinky Mixer (ARE-310) and a commercial ink making vehicle (ESL ElectroScience, type 441).

The prepared anode-supported full cells were then infiltrated with NiO-GDC precursor on the anode side. NiO-GDC (Ce_{0.9}Gd_{0.1}O_{2-δ}) precursor was prepared by dissolving nitrates of nickel, cerium, and gadolinium in H₂O. Five compositions were prepared GDC (Ce_{0.9}Gd_{0.1}O_{2-δ}), Ni10-GDC (10% Ni—Ce_{0.9}Gd_{0.1}O_{2-δ}), Ni50-GDC (50% Ni—Ce_{0.9}Gd_{0.1}O_{2-δ}), Ni75-GDC (75% Ni—Ce_{0.9}Gd_{0.1}O_{2-δ}), and Ni. A few drops of infiltrate solution were added on the porous scaffold and kept under vacuum for 10 minutes. Between each successive infiltration step, the sample was heat-treated at 400° C. for an hour to decompose the nitrate salts. The infiltration cycles were repeated to get approximate loading of ˜5 wt. % in all samples.

I-V characteristics and power density of the SOFCs (with an area 0.31 cm²) were determined using Solartron 1470E. The electrochemical impedance spectroscopy (EIS) response of the cells was obtained using a Solartron 1425 frequency response analyzer. The electrochemical performance including I-V and impedance spectra were determined using a fuel cell testing fixture loaded with the SOFC. Commercial two-part sealant (Ceramabond-517, Aremco) was used to seal anode and cathode compartments. The anode and cathode gas flow rates were 100 ml/min of humidified CH₄/H₂ gas mixture (CH₄:H₂ ratio of 1:5) and air, respectively. Impedance spectra were measured by 4-point probe method over a frequency range from 100 mHz to 100 kHz under open-circuit voltage (OCV) conditions. The impedance spectra were fitted with an equivalent circuit model using the code ZsimpWin with a complex non-linear square fitting routine (CNLS). Gold wires and silver paste were used as leads and the current collector, respectively for all SOFCs characterized in this study. Scanning electron microscopy (SEM) of the post-tested SOFCs was performed using a Hitachi SU-70 with a field emission gun equipped with a Bruker XFlash silicon drift EDS detector.

Results and Discussion

Surface modification of conductive ceramic anodes using nanostructured electrocatalysts is a facile approach to introduce catalytic activity which in turn can make them appropriate for LT-SOFCs. Nanoscale surface modifications using an electrocatalyst can suppress carbon formation, enhance fuel tolerance to sulfur, and facilitate oxidation of hydrocarbon fuels at lower temperatures. In addition, the porous ceramic support structures allow expansion and contraction of nanosized Ni, preventing the failure of Ni-GDC supported cells due to redox cycling instability.

This example demonstrates the performance of SFCM based anode-supported SOFCs at the temperature ranges between 550° C. to 650° C. The anode side of the SOFC was infiltrated with Ni-GDC to incorporate catalytic activity in ceramic oxides for fuel oxidation. The SOFC performance and characteristics were determined by varying the Ni concentration (modifying the Ni-to-GDC ratios) that was infiltrated in the SFCM ceramic scaffold. The long-term stability was determined over a period of 200 h in CH₄/H₂ gas mixtures for Ni10-GDC (low Ni-content, Ni-to-GDC ratio of 1:10), Ni50-GDC (high Ni-content, Ni-to-GDC ratio of 5:10) and Ni only infiltrated cells. The total Ni content in the anode of these infiltrates is <5 wt. % as compared to ˜50 wt. % of the typical Ni-cermet anode used to internally reform CH₄. SOFCs using this infiltrate SFCM anode are expected to utilize externally reformed CH₄ and as such a CH₄/H₂ gas mixture was used to evaluate SOFCs with SFMC having Ni-GDC infiltrates. The long-term microstructural stability of the SOFCs was also investigated in terms of the particle size distribution and resulting agglomeration based on various Ni-to-GDC ratios.

As discussed in detail below, the composition and the particle size of the infiltrated nanoparticles greatly affected the performance and long-term stability of the SOFCs. Some Ni-GDC infiltrated SOFCs showed peak power density of 0.75, 0.65 and 0.36 W/cm² at 650° C., 600° C., and 550° C., respectively, in humidified H2 and 0.62, 0.39 and 0.22 W/cm² at 650° C., 600° C., and 550° C., respectively, in CH₄-containing gases. A stable cell voltage of 0.82V is obtained over 200 h operations at a constant current of 0.2 A/cm² at 600° C. in CH₄-containing gases. The results show that highly stable SOFCs can be produced by carefully adjusting the quantity of Ni in the Ni-GDC infiltrate composition and by suppressing the grain growth of Ni nanoparticles.

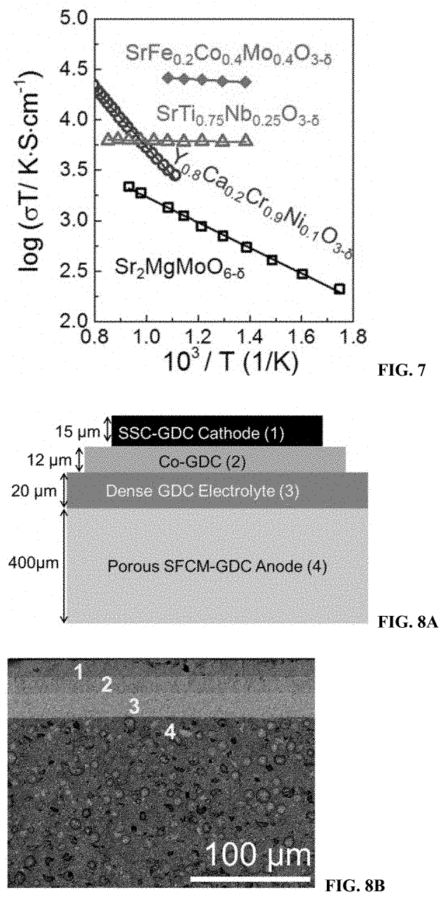

The crystal structure of SFCM is similar to that of a double perovskite oxide Sr₂CoMoO₆ (SCMO) or Sr₂FeMoO₆ (SFMO). The XRD data show the pure cubic double-perovskite phase without any impurities or secondary phases, e.g., SrMoO₄ or SrFeO_{3-δ}. The hopping of electrons in SCMO crystal lattice is sluggish; however, with the introduction of Fe-cation, the hopping of free electrons is significantly faster resulting in high electrical conductivity. The temperature-dependent electrical conductivity of SFCM in reducing gas conditions is shown in FIG. 7. SFCM has an electrical conductivity of 28 and 32 S/cm at 650° C. and 450° C., respectively. The increase in electrical conductivity of SFCM anode with a decrease in temperature denotes metallic-type conduction behavior. The electrical conductivity of representative ceramic oxides suitable for LT-SOFCs are also shown in FIG. 7, the electrical conductivity of molybdates e.g., Sr₂MgMoO_{6-δ} (SMMO) is 1.5 S/cm at 650° C., are 95% lower than the SFCM at that temperature. In addition, SFCM can be easily sintered in air, which makes the fabrication of SFCM-based cells much easier than that of SMMO. The electrical conductivity of titanates, e.g., SrTi_{0.75}Nb_{0.25}O_{3-δ} and chromates, e.g., Y_{0.8}Ca_{0.2}Cr_{0.9}Ni_{0.1}O_{3-δ} are 6.7 and 3.4 S/cm at 650° C., respectively. These values are still lower than the electrical conductivity of SFCM, and moreover, SFCM was reduced at a low temperature of 650° C., while all other ceramic anodes were reduced at high temperature (>900° C.). It is note-worthy to mention that low-temperature reduction is advantageous for using ceria-based electrolytes, as it undergoes Ce⁴⁺ to Ce³⁺ reduction leading to electronic leakage current followed by low OCV values.

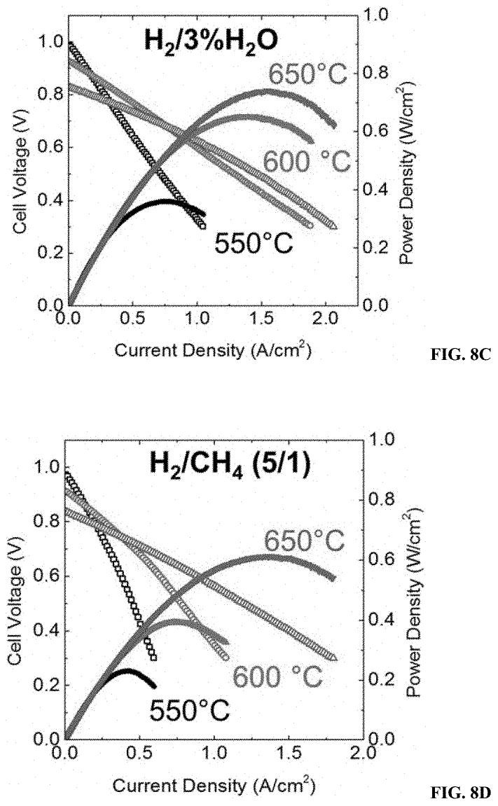

The anode-supported SOFC under investigation is shown in FIG. 8A. The SOFC structure consists of porous SFCM anode-support and the anode support is deposited with 20 and 12 μm-thick dense GDC electrolyte and Co-GDC CFL, respectively, the cell further consists of a 12 μm-thick porous SSC-GDC cathode. SEM cross-sectional micrograph of the SOFC is shown in FIG. 8 (the labels 1, 2, 3 and 4 indicate the SOFC components corresponding to those in FIG. 7).

At low-temperatures, SFCM-based anodes have a negligible catalytic activity for fuel oxidation. Thus, a Ni-GDC electrocatalyst was infiltrated into the porous SFCM scaffold to introduce catalytic activity for fuel oxidation. Current-voltage (“I-V”) characteristics and power density curves of Ni10-GDC infiltrated SFCM measured in H₂/H₂O and CH₄/H₂ gas mixtures are shown in FIGS. 8C and 8D, respectively. In both cases, OCV values increase with a decrease in temperature due to increase in ionic transference number of GDC electrolyte. For the Ni10-GDC infiltrated SFCM sample measured in humidified H₂, the OCV values at 650° C., 600° C., and 550° C. is 0.829, 0.926 and 0.987 V, respectively. Similarly, the OCV values measured in humidified CH₄/H₂ gas mixture are 0.836, 0.911 and 0.972 V at 650° C., 600° C., and 550° C., respectively. The OCV values measured for CH₄/H₂ gas mixtures are slightly higher (0.8% at 650° C.) than the ones measured in H₂. Without being bound by any theory, it is believed that this is because CH₄ has lower oxygen partial pressure (PO₂) than H₂ at a temperature>550° C. The theoretical OCV of humidified CH₄ is 1.165 Vat 650° C., whereas for humidified H₂ the value is 1.127 Vat 650° C. The peak power densities (PPD) of the SOFC measured under humidified H₂ are 0.75, 0.65 and 0.36 W/cm² at 650° C., 600° C., and 550° C., respectively. PPD for the same samples in CH₄/H₂ gas mixtures are 0.62, 0.39 and 0.22 W/cm² at 650° C., 600° C., and 550° C., respectively. The lower PPD in the presence of CH₄ is attributed to the higher ohmic and nonohmic ASR values.

The impedance spectra under OCV measured in CH₄/H₂ gas atmosphere are shown in FIG. 8E. The impedance spectra show overlapped contributions from electrolyte, cathode, and anode. Typically, the ohmic ASR develops from both electrode and electrolyte contributions, however considering the high electrical conductivity of anode and cathode, the electrode ohmic contributions are negligible. The ohmic ASR values for Ni10-GDC infiltrated SFCM samples tested in humidified H₂ is 0.168, 0.271 and 0.477 Ωcm² at 650° C., 600° C., and 550° C., respectively, and 0.195, 0.314 and 0.561 Ωcm² at 650° C., 600° C., and 550° C., respectively, under humidified CH₄/H₂ gas mixtures. The non-ohmic ASR originates from the electrode processes associated with the charge-transfer resistances at the electrode/electrolyte interfaces (high-frequency arc) and adsorption/gas diffusion resistance (low-frequency arc). It is highly difficult to separate the contributions of anode and cathode due to the overlapping time constants attributed to each electrode process. The non-ohmic ASR for the samples measured in humidified H₂ are 0.022, 0.038 and 0.18 Ωcm² at 650° C., 600° C., and 550° C., respectively. For the same cell measured in humidified CH₄/H₂ gas mixtures, the non-ohmic ASR values were 0.035, 0.095 and 0.28 Ωcm² at 650° C., 600° C., and 550° C., respectively, almost doubled, as oxidation of CH₄ has a higher energy barrier than H₂, resulting in a higher anode overpotential.

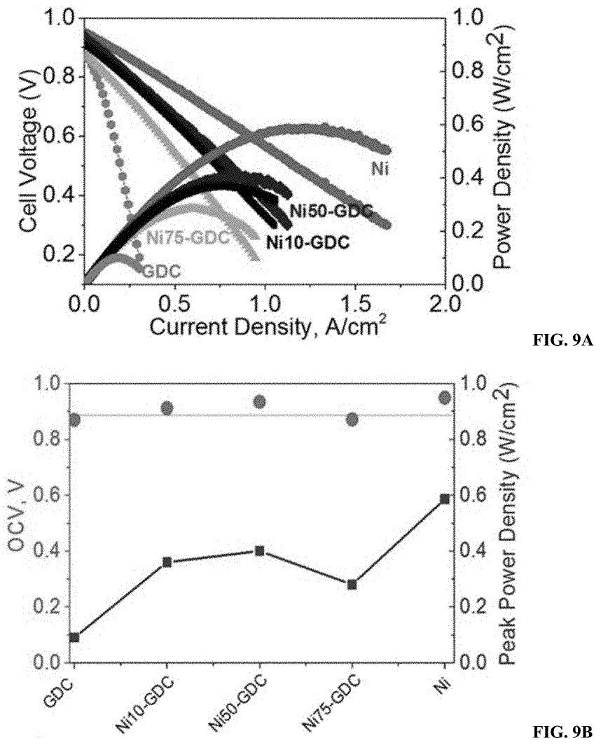

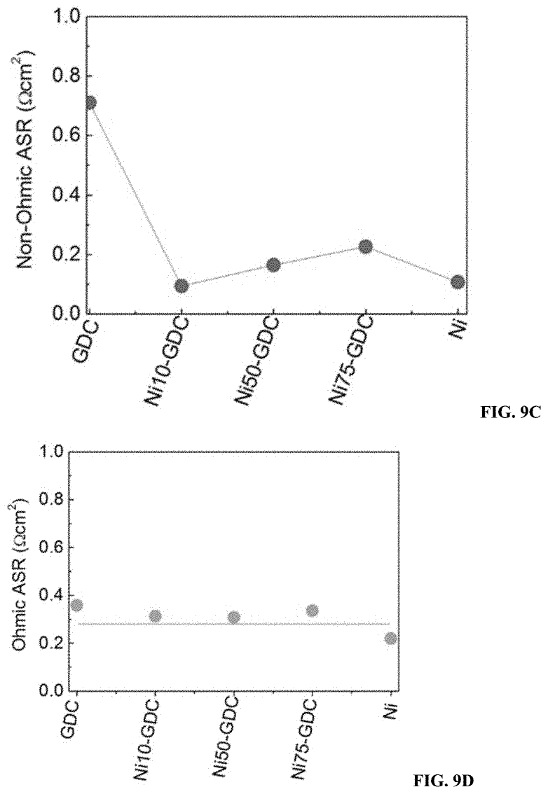

The performance of the SFCM based anode-supported SOFCs depend on the Ni-to-GDC ratio that was infiltrated in the porous support. FIGS. 9A-9D show the I-V characteristics and performance of SFCM based SOFCs infiltrated with varying Ni-to-GDC ratios (GDC, Ni10-GDC, Ni50-GDC, Ni75-GDC and Ni) at 600° C. in CH₄/H₂ gas mixtures. These ratios correspond to an increasing amount of Ni needed to determine the optimum composition that can demonstrate maximum performance (without affecting the stability). FIG. 9A shows the I-V and power density characterizations of SOFCs measured in CH₄/H₂ gas mixtures at 600° C. The changes in OCV, PPD, ohmic and non-ohmic ASR values are shown in FIGS. 9B-9D. FIG. 9B shows the OCV values for different samples obtained by varying Ni-to-GDC ratios were examined. The OCV values vary slightly depending on the effectiveness of gas sealing, however, the variations are negligible. The PPD of the SOFCs were 0.09, 0.36, 0.40, 0.28 and 0.59 W/cm² for GDC, Ni10-GDC, Ni50-GDC, Ni75-GDC and Ni only infiltrated SFCM cells, respectively. The initial PPD of the GDC infiltrated SFCM cell is 4× lower than Ni10-GDC, and the Ni only infiltrated cell is 1.5× higher, which could be associated with the relatively low catalytic activity of GDC, and high catalytic activity of Ni for oxidation of fuels, respectively.

As shown in FIG. 9C, the non-ohmic ASR for GDC only infiltrated SFCM cells shows a high value of 0.7 Ωcm² when compared to Ni-GDC or Ni only infiltrated SFCM cells. With a slight addition of Ni, e.g., Ni10-GDC, the non-ohmic ASR decreases drastically to the lowest value of 0.092 Ωcm². However, with further increase in Ni-content, the non-ohmic ASR increases due to agglomeration of Ni particles and decrease of surface area. A value of 0.2 and 0.28 Ωcm² is obtained for Ni50-GDC and Ni75-GDC infiltrated SFCM cells, respectively. Interestingly, the non-ohmic ASR value significantly decreases (0.094 Ωcm²) for Ni only infiltrated SFCM cells. It is likely that infiltrated Ni-particles have much faster oxidation kinetics, however, the performance was not stable due to coarsening of Ni caused by Ostwald ripening mechanism.

The ohmic ASR shown in FIG. 9D indicates a slight variation between Ni-GDC infiltrated SFCM cells measured in CH₄/H₂ gas mixtures. For GDC only infiltrated SFCM cells, the ohmic ASR of 0.36 Ωcm² is higher due to a low electronic conductivity of GDC and for Ni only infiltrated SFCM cell, high particle-particle connectivity is achieved resulting in a low ohmic ASR of 0.25 Ωcm².

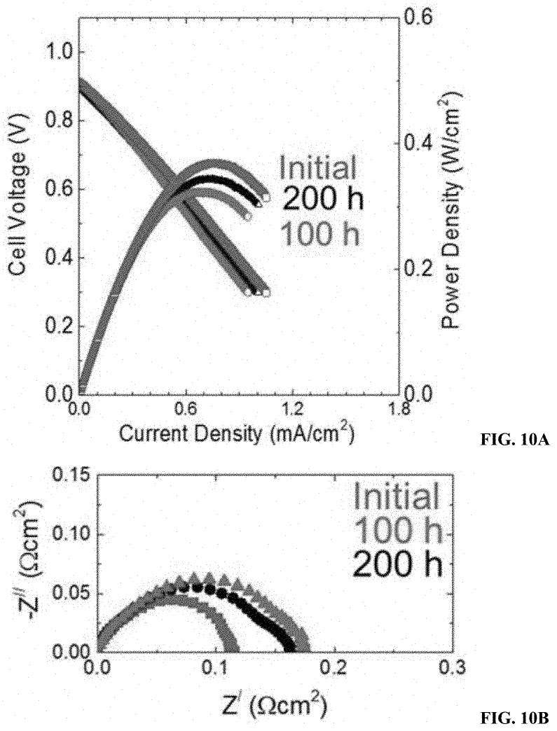

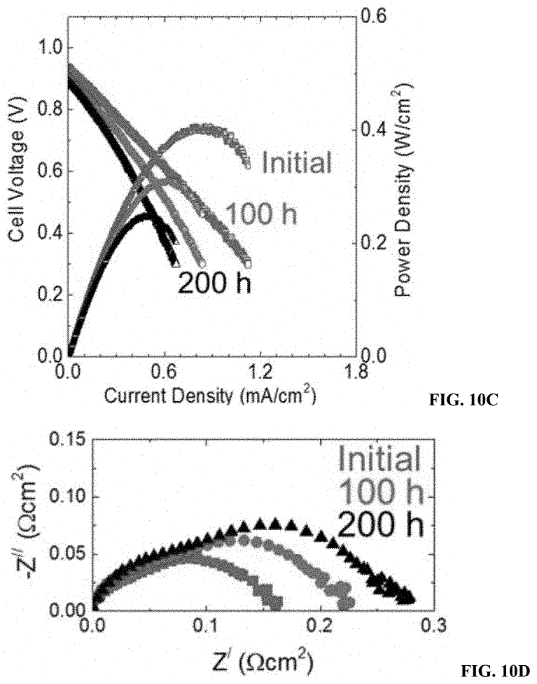

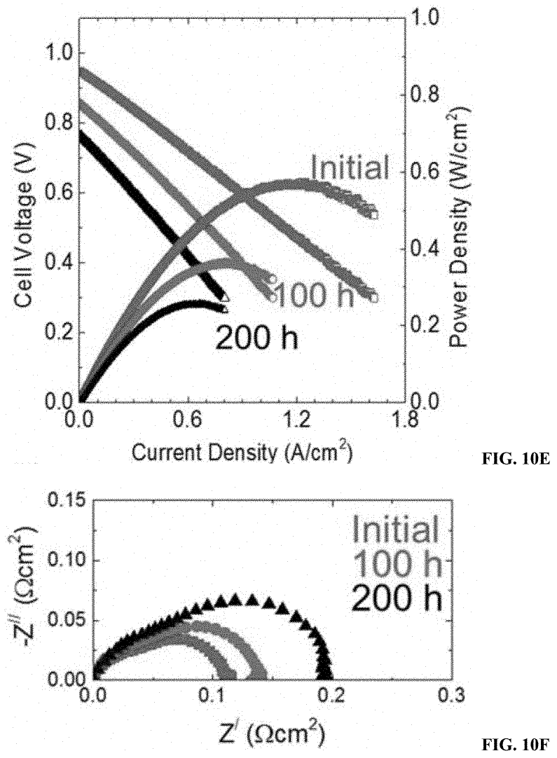

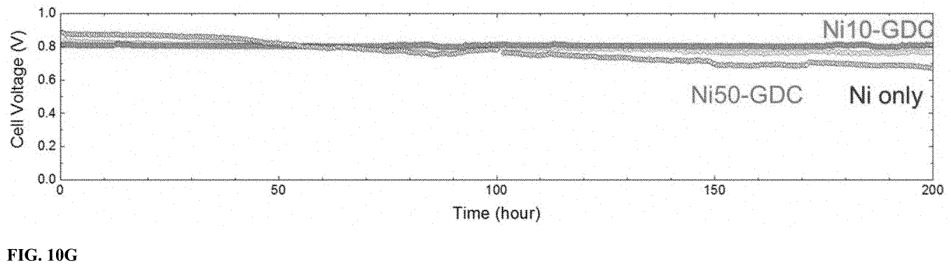

I-V characteristics and EIS measurements at initial, 100^{th} and 200^{th} hour are shown in FIGS. 10A-10F. I-V characteristics shown in FIG. 10A are for Ni10-GDC infiltrated SFCM cell and the impedance in FIG. 10B. The PPD of the sample shows no significant changes after 200 h of operation. However, a slight drop from 0.39 W/cm² to 0.33 W/cm² occurs at the first 100 h and then PPD recovers back to essentially the original value at 200^{th} h. The initial non-ohmic ASR of 0.12 Ωcm² increases to 0.175 Ωcm² and stabilizes with slight fluctuations. The values of the ohmic ASR are 0.35, 0.33 and 0.37 Ωcm² for the sample measured at initial, 100^{th} h and 200^{th} h, respectively, these values are subtracted for easy comparison of non-ohmic ASR.

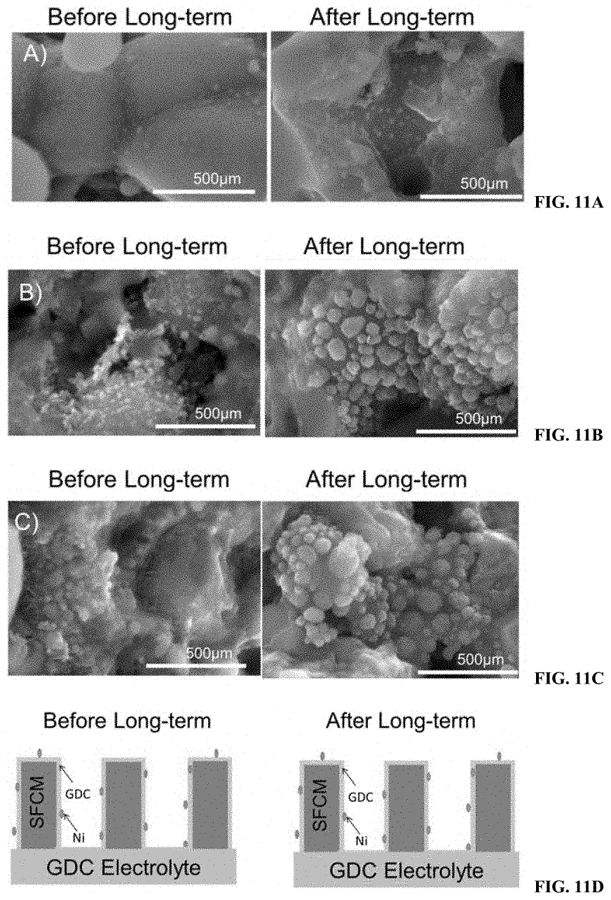

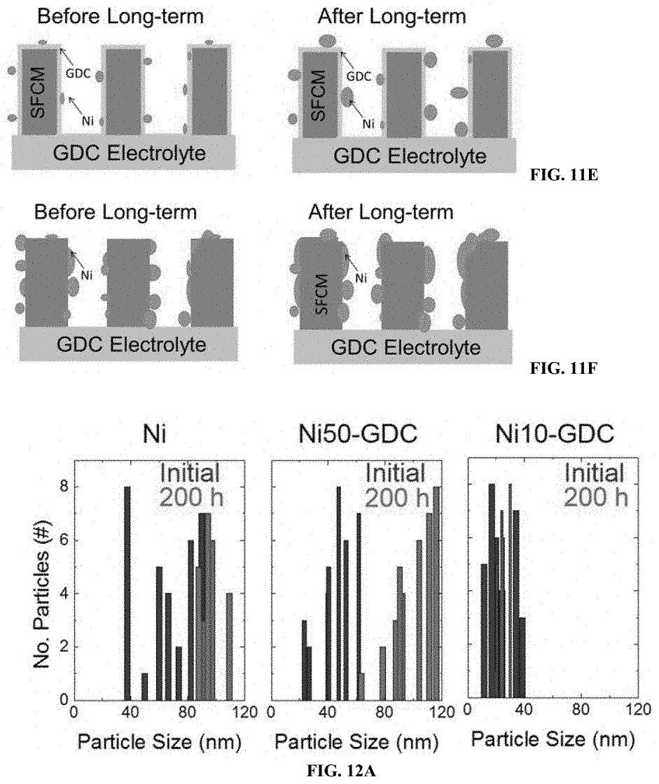

For the Ni50-GDC infiltrated SFCM cell, the I-V characteristics and impedance spectra are shown in FIGS. 10C and 10D, respectively. As shown in FIG. 10C, the PPD values decrease from 0.4 W/cm² to 0.25 W/cm² over a period of 200 h, accompanied by the decrease in OCV. As shown in FIG. 10D, the non-ohmic ASR of these cells increases over time due to Ni agglomeration (the corresponding SEM images can be seen later in FIGS. 11A-11F). The ohmic ASR values are 0.31, 0.29 and 0.29 Ωcm², for the samples measured initial, 100^{th} h and 200^{th} h, respectively. I-V characteristics and EIS of the Ni only catalyst is shown in FIGS. 10E and 10F, respectively. The PPD and OCV values (FIG. 10E) significantly decrease and also, the non-ohmic ASR significantly increases over 200 h. The ohmic resistance values are 0.21, 0.26 and 0.28 Ωcm², the increase in ohmic and non-ohmic ASR could be associated with coarsening and agglomeration of Ni particles.

The long-term performance of Ni10-GDC, Ni50-GDC, and Ni infiltrated SFCM cells are compared in FIG. 10G. The long-term performance was determined in galvanostatic mode at a constant current of 0.2 A/cm². All measurements were conducted at 600° C. in CH₄/H₂ gas mixtures. As shown in FIG. 10G, Ni10-GDC (low Ni concentration, Ni-to-GDC, 1:10) infiltrated SFCM showed excellent stability with a cell voltage of 0.82 V over a period of 200 h. However, with Ni50-GDC (with high Ni concentration, Ni-to-GDC ratio of 5:10), the cell voltage degrades 17% over a period of 200 h. Further, the Ni only infiltrated SOFC degrades even more rapidly (24% over 200 h). It is believed that the reason behind the excellent stability of Ni10-GDC and a high degradation rate for higher Ni content is related to coarsening effect and is explained with the support of SEM micrographs.

SEM images with the schematic sketches depicting the grain growth/particle sizes of Ni-GDC on SFCM-GDC porous scaffold are shown in FIGS. 11A-11F. FIGS. 11A and 11D show the surface micrograph and schematic of Ni10-GDC infiltrated SFCM before and after 200 h. The particle size of Ni in Ni10-GDC is maintained after 200 h of operation, leading to excellent stability even in CH₄/H₂ gas environment. The retention of small particle sizes resulted in surface area improvement and high catalytic activity. Without being bound by any theory, it is believed that a relatively large amount of infiltrated GDC (compared to infiltrated Ni) likely prevents the agglomeration of Ni, preventing Ni particle size growth. FIGS. 11B and 11E compare the micrograph of Ni50-GDC composition on SFCM-GDC anode before and after long-term test of 200 h along with schematic sketch, respectively. The particle sizes grow considerably (after the long-term test) due to Ni agglomeration in the Ni50-GDC composition, which decreases available surface area, hindering the performance and long-term stability. For Ni only infiltration shown in FIGS. 11C and 11F, the rate of Ni particle growth rate is much higher, affecting the stability and performance significantly.

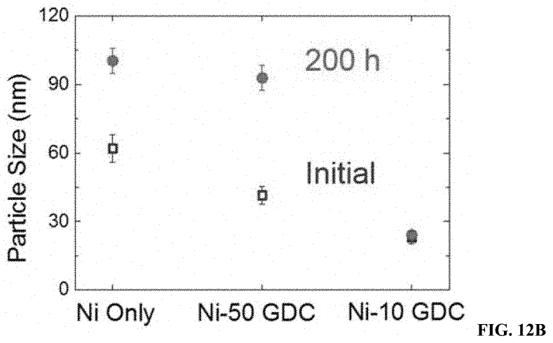

The particle size distributions of Ni, Ni50-GDC and Ni10-GDC electrocatalysts on SFCM-GDC ceramic anodes, determined by using SEM images are shown in FIGS. 12A and 12B. As shown in FIG. 12A, the particle size distributions for Ni and Ni50-GDC varies considerably, however, Ni10-GDC retains the original particle sizes even after 200 h. The average particle sizes of Ni only, Ni50-GDC and Ni10-GDC electrocatalyst before and after long-term experiments are compared in FIG. 12B. The graph demonstrates that the particle size of Ni and Ni50-GDC (Ni-to-GDC ratio of 5:10) almost doubles after 200 h, while the particles retain the same for Ni10-GDC (Ni-to-GDC ratio of 1:10).

Conclusion: Anode-supported SOFCs were made with a SFCM-GDC ceramic anode infiltrated with an electrocatalyst having various Ni-to-GDC ratios. A composition with low Ni content (Ni-to-GDC ratio of 1:10) showed the high SOFC performance of 0.75, 0.65 and 0.36 W/cm² at 650° C., 600° C., and 550° C., respectively, in humidified Hz. Further, the performance and long-term stability of the SOFCs were determined in CH₄/H₂ gas mixtures. The same composition (Ni-to-GDC ratio of 1:10) showed stable performance without degradation over a period of 200 h. It is believed that the reason for this improvement is due to suppressed particle growth of Ni nanoparticles coated or infiltrated on the surface of SFCM.

The foregoing discussion of the examples has been presented for purposes of illustration and description. The foregoing is not intended to limit the disclosure or claimed subject matter to the form or forms disclosed herein. Although the description included discussion of one or more example embodiments and certain variations and modifications, other variations and modifications are within the scope of the present disclosure, e.g., as may be within the skill and knowledge of those in the art, after understanding the present disclosure. It is intended to obtain rights which, include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. All references cited herein are incorporated by reference in their entirety.

What is claimed is:

1. A stable ceramic anode composition for a solid oxide fuel cell (SOFC) having a porous surface, said stable ceramic anode composition comprising:
strontium-iron-cobalt-molybdenum oxide material (SFCM);
a first ion-conductor composition comprising an oxide of cerium or cerium that is doped with a rare-earth metal; and
nanoparticles of an electrocatalyst comprising (a) a second ion conductor and (b) nickel, a nickel alloy, or a combination thereof, wherein said nanoparticles are infiltrated within said porous surface of said stable ceramic anode,
wherein a total amount of said electrocatalyst in said stable ceramic anode is about 10% by weight or less.

2. The stable ceramic anode composition of claim 1, wherein a total amount of said electrocatalyst in said stable ceramic anode of said infiltration is 5% or less by weight.

3. The stable ceramic anode composition of claim 1, wherein an average particle size of said nanoparticles is about 200 nm or less.

4. The stable ceramic anode composition of claim 1, wherein a ratio of SFCM to said first ion-conductor composition is from about 5:1 to about 1:1 by weight.

5. The stable ceramic anode composition of claim 1, wherein said rare-earth metal is a lanthanide metal.

6. The stable ceramic anode composition of claim 1, wherein said second ion-conductor further comprises an oxide of cerium or cerium that is doped with a rare-earth metal.

7. The stable ceramic anode composition of claim 1, wherein said nickel alloy comprises cobalt, iron, tin, or a combination thereof.

8. The stable ceramic anode composition of claim 1, wherein said electrocatalyst comprises nickel and gadolinium cerium oxide (Ni-GDC).

9. The stable ceramic anode composition of claim 8, wherein ratio of nickel to gadolinium cerium oxide in said Ni-GDC electrocatalyst is 1:4 or less on an atom basis.

10. The stable ceramic anode composition of claim 1, wherein said SFCM oxide material is of the formula: SrFeₓCo_{((1-x)/2)}Mo_{((1-x)/2)}O_{3±δ}, wherein x is 0.1-0.5 and δ is 0-1.5.

11. The stable ceramic anode composition of claim 1, wherein said first ion-conductor composition comprises gadolinium-doped cerium oxide (GDC).

12. The stable ceramic anode composition of claim 11, wherein said GDC is doped with cobalt.

13. The stable ceramic anode composition of claim 12, wherein an amount of cobalt in said GDC is about 10 wt % or less.

14. The stable ceramic anode composition of claim 1, wherein a reduction of cell voltage in galvanostatic mode of a SOFC comprising said stable ceramic anode over a period of 200 h is less than 15%.

15. A solid oxide fuel cell comprising:
(a) a cathode layer;
(b) a stable ceramic anode layer having a less than 15% cell voltage reduction in galvanostatic mode over a period of 200 h; and
(c) an electrolyte layer located between said cathode layer and said ceramic anode layer.

16. The solid oxide fuel cell of claim 15, wherein said stable ceramic anode layer comprises:
strontium-iron-cobalt-molybdenum oxide material (SFCM) of the formula: SrFeₓCo_{((1-x)/2)}Mo_{((1-x)/2)}O_{3±δ}, wherein x is 0.1-0.5 and δ is 0-1.5;
a first ion-conductor composition comprising an oxide of cerium or cerium that is doped with a rare-earth metal; and
nanoparticles of an electrocatalyst comprising (a) a second ion-conductor and (b) nickel, a nickel alloy, or a combination thereof,
wherein said nanoparticles of said electrocatalyst are infiltrated within a porous surface of said stable ceramic anode.

17. The solid oxide fuel cell according to claim 16, wherein a total amount of said nickel in said stable ceramic anode of said infiltration is 10% or less of total electrocatalyst composition.

18. The solid oxide fuel cell of claim 16, wherein said electrocatalyst comprises nickel and gadolinium cerium oxide (Ni-GDC).

19. The solid oxide fuel cell of claim 18, wherein ratio of nickel to gadolinium cerium oxide in said Ni-GDC electrocatalyst is 1:4 or less on an atom basis.

20. The solid oxide fuel cell of claim 16, wherein said second ion-conductor comprises an oxide of cerium or cerium that is doped with a rare-earth metal.
